(19) United States
(12) Patent Application Publication
(10) Pub. No.: US 2024/0209203 A1
(43) Pub. Date: Jun. 27, 2024

(54) Thermally Conductive Polymer Composition

(71) Applicant: Ticona LLC, Florence, KY (US)

(72) Inventors: Guodong Deng, Union, KY (US); Prabuddha Bansal, Florence, KY (US); Yuehua Yu, Cincinnati, OH (US); Katrina Czenkusch, Elsmere, KY (US); Brian Hokkanen, Union, KY (US); Christopher McGrady, Walton, KY (US); Raghavendra Maddikeri, Union, KY (US); Sean Culligan, Zionsville, IN (US); Chongwen Huang, Union, KY (US); Paul Kenny, Galesville, WI (US)

(21) Appl. No.: 18/503,631

(22) Filed: Nov. 7, 2023

Related U.S. Application Data
(60) Provisional application No. 63/432,125, filed on Dec. 13, 2022.

(51) Int. Cl. C08L 67/02; C08K 3/013; C08K 3/22; C08K 3/34; C08K 7/14

(52) U.S. Cl. CPC C08L 67/02; C08K 3/013; C08K 3/22; C08K 3/34; C08K 7/14; C08K 2201/003; C08K 2201/006; C08L 2203/20

(57) ABSTRACT

A polymer composition that includes an aromatic polyester and an inorganic filler dispersed within the polymer matrix that includes inorganic particles and optionally inorganic fibers is provided. The inorganic filler is present in an amount of from about 60 parts to about 200 parts by weight of the polymer matrix and the inorganic particles are present in an amount of from about 40 to about 200 parts by weight of the polymer matrix. The polymer composition exhibits an in-plane thermal conductivity of about 1.5 W/m-K or more as and a melt flow rate of from about 0.1 to about 50 g/10 min.

### RELATED APPLICATION

The present application is based upon and claims priority to U.S. Provisional Patent Application Ser. No. 63/432,125, having a filing date of Dec. 13, 2022, which is incorporated herein by reference.

### BACKGROUND OF THE INVENTION

Electronic modules typically contain electronic components (e.g., printed circuit board, antenna elements, radio frequency devices, sensors, light sensing and/or transmitting elements (e.g., fibers optics), cameras, global positioning devices, etc.) that are received within a housing structure to protect them from weather, such as sunlight, wind, and moisture. Typically, such housings are formed from materials that allow the passage of electromagnetic signals (e.g., radiofrequency signals or light). While these materials are suitable in some applications, problems can nevertheless occur at higher frequency ranges, such as those associated with LTE or 5G systems. A radar module, for instance, typically contains one or more printed circuit boards having electrical components dedicated to handling radio frequency (RF) radar signals, digital signal processing tasks, etc. To ensure that these components operate effectively at high frequencies, they are generally received in a housing structure and then covered with a radome that is transparent to radio waves. Generally, a heat sink (e.g., thermal pad) is employed on the circuit board to help draw heat away from the components. Unfortunately, the addition of such components can add a substantial amount of cost and weight to the resulting module, which is particularly disadvantageous as the automotive industry is continuing to require smaller and lighter components. As such, a need currently exists for an electronic module that does not require the need for additional heat sinks.

### SUMMARY OF THE INVENTION

In accordance with one embodiment of the present invention, a polymer composition is disclosed that comprises a polymer matrix that includes an aromatic polyester and an inorganic filler dispersed within the polymer matrix that includes inorganic particles and optionally inorganic fibers. The inorganic filler is present in an amount of from about 60 parts to about 200 parts by weight of the polymer matrix and the inorganic particles are present in an amount of from about 40 to about 200 parts by weight of the polymer matrix. The polymer composition exhibits an in-plane thermal conductivity of about 1.5 W/m-K or more as determined in accordance with ASTM E1461-13(2022) and a melt flow rate of from about 0.1 to about 50 g/10 min as determined in accordance with ISO 1133:2022 at a temperature of about 250° C. and load of 2.16 kg.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is an exploded perspective view of one embodiment of an electronic module that may employ the polymer composition of the present invention; and

FIG. 2 depicts one embodiment of a 5G system that may employ the polymer composition of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition includes an aromatic polyester and an inorganic filler dispersed within the polymer matrix that includes inorganic fibers and, optionally, inorganic fibers (e.g., glass fibers). By selectively controlling the specific nature and relative concentration of the components of the polymer composition, the present inventors have discovered that the resulting composition can exhibit a unique combination of properties that enables it to be readily employed in a wide variety of product applications (e.g., electric vehicle) even at relatively small part thickness values, such as about 4 millimeters or less, in some embodiments about from about 0.2 to about 3.2 millimeters, in some embodiments from about 0.4 to about 2.5 millimeters, and in some embodiments, from about 0.8 to about 2 millimeters.

The polymer composition may, for example, exhibit an in-plane (or “flow”) thermal conductivity of about 1.5 W/m-K or more, in some embodiments about 2 W/m-K or more, in some embodiments about 3 to about 8 W/m-K, and in some embodiments, from about 4 to about 6 W/m-K, as determined in accordance with ASTM E 1461-13(2022). Similarly, the polymer composition may exhibit a cross-plane (or “cross-flow”) thermal conductivity of about 1 W/m-K or more, in some embodiments about 2 W/m-K or more, in some embodiments about 2.5 to about 8 W/m-K, and in some embodiments, from about 3 to about 6 W/m-K, as determined in accordance with ASTM E 1461-13(2022). The composition may also exhibit a through-plane thermal conductivity of about 0.2 W/m-K or more, in some embodiments about 0.4 W/m-K or more, in some embodiments about 0.5 to about 4 W/m-K, and in some embodiments, from about 0.6 to about 2 W/m-K, as determined in accordance with ASTM E 1461-13(2022). Such high thermal conductivity values allow the composition to be capable of creating a thermal pathway for heat transfer away from an electrical component within which it is employed. In this manner, “hot spots” can be quickly eliminated and the overall temperature can be lowered during use. Notably, it has been discovered that such a thermal conductivity can be achieved without use of conventional materials having a high degree of intrinsic thermal conductivity. For example, the polymer composition may be generally free of fillers having an intrinsic thermal conductivity of 50 W/m-K or more, in some embodiments 100 W/m-K or more, and in some embodiments, 150 W/m-K or more. Examples of such high intrinsic thermally conductive materials may include, for instance, boron nitride, aluminum nitride, magnesium silicon nitride, graphite (e.g., expanded graphite), silicon carbide, carbon nanotubes, zinc oxide, magnesium oxide, beryllium oxide, zirconium oxide, yttrium oxide, aluminum powder, and copper powder. While it is normally desired to minimize the presence of such high intrinsic thermally conductive materials, they may nevertheless be present in a relatively small percentage in certain embodiments, such as in an amount of about 10 wt. % or less, in some embodiments about 5 wt. % or less, and in some embodiments, from about 0.01 wt. % to about 2 wt. % of the polymer composition.

While exhibiting good thermal conductivity, the composition may still exhibit good flow properties as reflected by a melt flow rate such of from about 0.5 to about 50 grams per 10 minutes (g/10 min) or more, in some embodiments from about 1 to about 40 g/10 min, in some embodiments about from about 2 to about 30 g/10 min, and in some embodiments, from about 3 to about 20 g/10 min, as determined in accordance with ISO 1133:2022 at about 250° C. and load of 2.16 kilograms. The polymer composition may also exhibit a high degree of insulative properties, which may be characterized by a high comparative tracking index (“CTI”), such as about 400 volts or more, in some embodiments about 450 volts or more, in some embodiments about 500 volts or more, in some embodiments about 550 volts or more, in some embodiments about 580 volts or more, and in some embodiments, about 600 volts or more, as determined in accordance with IEC 60112:2020 at a part thickness such as noted above (e.g., 3 millimeters).

Despite having good flow properties and a high degree of insulative properties, the polymer composition may nevertheless maintain a high degree of strength, which can provide enhanced flexibility for the resulting component. The polymer composition may, for example, exhibit a tensile stress at break (i.e., strength) of from about 10 MPa to about 300 MPa, in some embodiments from about 20 MPa to about 200 MPa, and in some embodiments, from about 40 to about 100 MPa; a tensile break strain (i.e., elongation) of about 0.3% or more, in some embodiments from about 0.4% to about 8%, and in some embodiments, from about 0.5% to about 5%; and/or a tensile modulus of from about 5,000 to about 30,000 MPa, in some embodiments from about 6,000 MPa to about 25,000 MPa, and in some embodiments, from about 10,000 MPa to about 22,000 MPa. The tensile properties may be determined in accordance with ISO 527:2019 at a temperature of 23° C. The composition may also exhibit a flexural strength of about 20 MPa or more, in some embodiments from about 25 to about 200 MPa, in some embodiments from about 30 to about 150 MPa, and in some embodiments, from about 35 to about 100 MPa and/or a flexural modulus of about 10,000 MPa or less, in some embodiments from about 500 MPa to about 8,000 MPa, in some embodiments from about 1,000 MPa to about 6,000 MPa, and in some embodiments, from about 1,500 MPa to about 5,000 MPa. The flexural properties may be determined in accordance with ISO 178:2019 at a temperature of 23° C. The polymer composition may also exhibit a high impact strength, which can provide enhanced flexibility for the resulting part. For example, the polymer composition may exhibit an unnotched Charpy impact strength of about 2 kJ/m² or more, in some embodiments from about 5 to about 40 kJ/m², and in some embodiments, from about 10 to about 30 kJ/m², as determined at a temperature of 23° C. in accordance with ISO 179-1:2010.

The polymer composition may also be “hydrolytically resistant” in that it is not highly sensitive to the presence of saturated steam at a temperature of 121° C. In other words, even when exposed to steam at such a high temperature, the mechanical properties (e.g., impact strength, tensile properties, etc.) may remain close to or even within the ranges noted above. The mechanical properties can also remain stable at such temperatures for a substantial period of time, such as for about 20 hours or more, in some embodiments from about 50 hours to about 500 hours, and in some embodiments, from about 80 hours to about 200 hours (e.g., 96 or 168 hours). After “aging” at 121° C. for 96 hours while in contact with saturated steam, for example, the ratio of the aged tensile strength to the initial tensile strength prior to such aging may be about 0.8 or more, in some embodiments about 0.85 or more, and in some embodiments, from about 0.9 to 1.0; the ratio of the aged tensile elongation to the initial tensile elongation prior to such aging may be about 0.7 or more, in some embodiments about 0.75 or more, and in some embodiments, from about 0.8 to 1.0; and/or the ratio of the aged tensile modulus to the initial tensile modulus prior to such aging may be about 0.8 or more, in some embodiments about 0.85 or more, and in some embodiments, from about 0.9 to 1.2. After aging at 121° C. for 96 hours while in contact with saturated steam, the ratio of the aged Charpy notched impact strength to the initial impact strength prior to such aging may also be about 0.6 or more, in some embodiments about 0.7 or more, and in some embodiments, from about 0.8 to 1.0.

The polymer composition may also exhibit good heat resistance and flame retardancy. The melting temperature of the composition may, for instance, be from about 150° C. to about 300° C., in some embodiments from about 180° C. to about 280° C., and in some embodiments, from about 210° C. to about 250° C. (e.g., 225° C.). Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.65 to about 0.9. The specific DTUL values may, for instance, range be about 260° C. or more, in some embodiments from about 120° C. to about 300° C., and in some embodiments, from about 150° C. to about 220° C., such as determined in accordance with ISO 75:2013 at a load of 1.8 MPa. Such high DTUL values can, among other things, allow the use of high speed and reliable surface mounting processes for mating the structure with other components of an electrical component. The flame retardant properties of the composition may likewise be characterized in accordance the procedure of Underwriter's Laboratory Bulletin 94 entitled “Tests for Flammability of Plastic Materials, UL94.” Several ratings can be applied based on the time to extinguish ((total flame time of a set of 5 specimens) and ability to resist dripping as described in more detail below. According to this procedure, for example, the composition may exhibit at least a V2 rating at a part thickness such as noted above (e.g., from about 0.4 to about 3.2 millimeters, e.g., 0.4, 0.8, or 1.6 millimeters), which means that it has a total flaming combustion time of about 250 seconds or less. To achieve a V0 rating, the composition may exhibit a total flaming combustion time of about 50 seconds or less and a total number of drips of burning particles that ignite cotton of 0.

Various embodiments of the present invention will now be described in more detail.

### I. Polymer Composition

### A. Polymer Matrix

The polymer matrix typically constitutes from about 20 wt. % to about 60 wt. %, in some embodiments from about 25 wt. % to about 55 wt. %, and in some embodiments, from about 30 wt. % to about 50 wt. % of the polymer composition. The polymer matrix contains at least one aromatic polyester. For example, aromatic polyesters typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %).

One example of a suitable aromatic polyester may, for instance, include a condensation product of at least one diol (e.g., aliphatic and/or cycloaliphatic) with at least one aromatic dicarboxylic acid, such as those having from 4 to 20 carbon atoms, and in some embodiments, from 8 to 14 carbon atoms. Suitable diols may include, for instance, neopentyl glycol, cyclohexanedimethanol, 2,2-dimethyl-1,3-propane diol and aliphatic glycols of the formula HO(CH₂)ₙOH where n is an integer of 2 to 10. Suitable aromatic dicarboxylic acids may include, for instance, isophthalic acid, terephthalic acid, 1,2-di(p-carboxyphenyl)ethane, 4,4′-dicarboxydiphenyl ether, etc., as well as combinations thereof. Fused rings can also be present such as in 1,4- or 1,5- or 2,6-naphthalene-dicarboxylic acids. Particular examples of such aromatic polyesters may include, for instance, poly(ethylene terephthalate) (PET), poly(1,4-butylene terephthalate) (PBT), poly(1,3-propylene terephthalate) (PPT), poly(1,4-butylene 2,6-naphthalate) (PBN), poly(ethylene 2,6-naphthalate) (PEN), poly(1,4-cyclohexylene dimethylene terephthalate) (PCT), as well as mixtures of the foregoing.

Derivatives and/or copolymers of aromatic polyesters (e.g., polyethylene terephthalate) may also be employed. For instance, in one embodiment, a modifying acid and/or diol may be used to form a derivative of such polymers. As used herein, the terms “modifying acid” and “modifying diol” are meant to define compounds that can form part of the acid and diol repeat units of a polyester, respectively, and which can modify a polyester to reduce its crystallinity or render the polyester amorphous. Examples of modifying acid components may include, but are not limited to, isophthalic acid, phthalic acid, 1,3-cyclohexanedicarboxylic acid, 1,4-cyclohexane dicarboxylic acid, 2,6-naphthaline dicarboxylic acid, succinic acid, glutaric acid, adipic acid, sebacic acid, suberic acid, 1,12-dodecanedioic acid, etc. In practice, it is often preferable to use a functional acid derivative thereof such as the dimethyl, diethyl, or dipropyl ester of the dicarboxylic acid. The anhydrides or acid halides of these acids also may be employed where practical. Examples of modifying diol components may include, but are not limited to, neopentyl glycol, 1,4-cyclohexanedimethanol, 1,2-propanediol, 1,3-propanediol, 2-methy-1,3-propanediol, 1,4-butanediol, 1,6-hexanediol, 1,2-cyclohexanediol, 1,4-cyclohexanediol, 1,2-cyclohexanedimethanol, 1,3-cyclohexanedimethanol, 2,2,4,4-tetramethyl 1,3-cyclobutane diol, Z,8-bis(hydroxymethyltricyclo-[5.2.1.0]-decane wherein Z represents 3, 4, or 5; 1,4-bis(2-hydroxyethoxy)benzene, 4,4′-bis(2-hydroxyethoxy) diphenylether [bis-hydroxyethyl bisphenol A], 4,4′-Bis(2-hydroxyethoxy)diphenylsulfide [bis-hydroxyethyl bisphenol S] and diols containing one or more oxygen atoms in the chain, e.g. diethylene glycol, triethylene glycol, dipropylene glycol, tripropylene glycol, etc. In general, these diols contain 2 to 18, and in some embodiments, 2 to 8 carbon atoms. Cycloaliphatic diols can be employed in their cis- or trans-configuration or as mixtures of both forms.

In certain cases, the aromatic polyester may contain a relatively small amount of carboxyl end groups to help improve hydrolytic resistance of the polymer composition. The aromatic polyester may, for instance, contain carboxyl end groups in an amount less than about 20 mmol/kg, such as less than about 18 mmol/kg, such as less than about 15 mmol/kg, and generally greater than about 1 mmol/kg. The amount of carboxyl end groups can be minimized on the polyester polymer using different techniques. For example, in one embodiment, the aromatic polyester can be contacted with an alcohol, such as benzyl alcohol, for decreasing the amount of carboxyl end groups. Each kilogram of the aromatic polyester resin may likewise contain fewer than 35, preferably fewer than 30, and more preferably fewer than 25, milliequivalents of carboxylic acid end groups. The milliequivalents of carboxylic acid end groups in the semi-aromatic polyester resin may be determined by any number of known titration methods. For instance, potentiometric titration may be employed in which the semi-aromatic polyester resin is dissolved in an appropriate solvent and then titrated with a base, such as potassium hydroxide, to the inflection point or end point.

The aromatic polyesters, such as described above, typically have a glass transition temperature of from about 30° C. to about 120° C., in some embodiments from about 40° C. to about 110° C., and in some embodiments, from about 50° C. to about 100° C., such as determined by ISO 11357-2:2020. The aromatic polyesters may also have an intrinsic viscosity of from about 0.1 dl/g to about 6 dl/g, in some embodiments from about 0.2 to about 5 dl/g, and in some embodiments from about 0.3 to about 1 dl/g, such as determined in accordance with ISO 1628-5:1998. The melt flow rate of the aromatic polyester may likewise may be from about 0.1 to about 50 grams per 10 minutes (“g/10 min”), in some embodiments from about 1 to about 35 g/10 min, and in some embodiments, from about 5 to about 20 g/10 min, as determined in accordance with ISO 1133:2022 at about 250° C. and a load of 2.16 kilograms.

### B. Inorganic Filler

The polymer composition also contains an inorganic filler distributed within the polymer matrix. The inorganic filler generally constitutes from about 60 to about 200 parts by weight, in some embodiments from about 75 to about 200 parts by weight, in some embodiments from about 90 to about 200 parts by weight, in some embodiments from about 100 to about 180 parts by weight, and in some embodiments, from about 120 to about 160 parts by weight per 100 parts by weight of the polymer matrix. The inorganic filler may, for instance, constitute from about 40 wt. % to about 80 wt. %, in some embodiments from about 45 wt. % to about 75 wt. %, and in some embodiments, from about 50 wt. % to about 70 wt. % of the polymer composition.

The inorganic filler may be formed entirely from inorganic particles, or the filler may contain a combination of inorganic particles and inorganic fibers. When such fibers are employed, they typically constitute from about 10 wt. % to about 60 wt. %, in some embodiments from about 15 wt. % to about 55 wt. %, and in some embodiments, from about 20 wt. % to about 50 wt. % of the inorganic filler, while the inorganic particles constitute from about 40 wt. % to about 90 wt. %, in some embodiments from about 45 wt. % to about 85 wt. %, and in some embodiments, from about 50 wt. % to about 70 wt. % of the inorganic filler. The inorganic particles may, for example, be present in an amount by weight greater than the inorganic fibers. Regardless, the total amount of the inorganic particles is generally from about 40 parts by weight to about 200 parts by weight, in some embodiments from about 50 to about 180 parts by weight, and in some embodiments, from about 60 to about 160 parts by weight per 100 parts by weight of the polymer matrix, and also from about 10 wt. % to about 80 wt. %, in some embodiments from about 15 wt. % to about 75 wt. %, and in some embodiments, from about 20 wt. % to about 70 wt. % of the polymer composition. When employed, the total amount of inorganic fibers is generally from about 10 parts by weight to about 100 parts by weight, in some embodiments from about 20 to about 90 parts by weight, and in some embodiments, from about 30 to about 80 parts by weight per 100 parts by weight of the polymer matrix, and also from about 1 wt. % to about 50 wt. %, in some embodiments from about 5 wt. % to about 45 wt. %, and in some embodiments, from about 10 wt. % to about 40 wt. % of the polymer composition.

A variety of inorganic particles may be employed to help achieve the desired properties of the polymer composition. In one one embodiment, for instance, the particles may be formed from a natural and/or synthetic metal silicate, such as talc, mica, halloysite, kaolinite, illite, montmorillonite, vermiculite, palygorskite, pyrophyllite, calcium silicate, aluminum silicate, wollastonite, etc. Talc is particularly suitable for use in the polymer composition. Metal hydroxide particles may also be employed that contain at least one metal hydroxide having the general formula: M(OH)ₐO_{b}, where 0≤a≤3 (e.g., 1), b=(3−a)/2, and M is a metal, such magnesium, aluminum, etc. Aluminum hydroxide particles are particularly suitable. In one embodiment, for example, the particles may exhibit a boehmite crystal phase and the aluminum hydroxide may have the formula AlO(OH) (“aluminum oxide hydroxide”). In addition to metal silicates and/or metal hydroxides, metal oxide particles may also be employed, such as titanium dioxide, magnesium oxide, zinc oxide, or a combination thereof.

The inorganic particles may be needle-shaped, ellipsoidal-shaped, platelet-shaped, spherical-shaped, granular, flaked-shaped, etc. In certain embodiments, the particles may have a microscale median particle diameter (D50) of from about 1 to about 25 micrometers, in some embodiments from about 2 to about 15 micrometers, and in some embodiments, from about 4 to about 10 micrometers, as determined by sedimentation analysis (e.g., Sedigraph 5120). Of course, smaller particles may be employed in certain circumstances. For example, particles may be employed that have a nanoscale medial particle diameter (D50), such as from about 50 to about 800 nanometers, in some embodiments from about 150 to about 700 nanometers, and in some embodiments, from about 250 to about 500 nanometers, as determined by non-invasive back scatter (NIBS) techniques. If desired, the particles may also have a high specific surface area, such as from about 1 square meters per gram (m²/g) to about 100 m²/g, in some embodiments from about 1.5 m²/g to about 50 m²/g, and in some embodiments, from about 2 m²/g to about 25 m²/g. Surface area may be determined by the physical gas adsorption (BET) method (nitrogen as the adsorption gas) in accordance with DIN 66131:1993. The moisture content may also be relatively low, such as about 5% or less, in some embodiments about 3% or less, and in some embodiments, from about 0.1 to about 1% as determined in accordance with ISO 787-2:1981 at a temperature of 105° C.

When employed, inorganic fibers may help further improve the thermal and mechanical properties of the composition. The inorganic fibers typically have a high degree of tensile strength relative to their mass. For example, the ultimate tensile strength of the fibers (determined in accordance with ASTM D822/D822M-13 (2018)) is typically from about 1,000 to about 15,000 Megapascals (“MPa”), in some embodiments from about 2,000 MPa to about 10,000 MPa, and in some embodiments, from about 3,000 MPa to about 6,000 MPa. Further, although the fibers may have a variety of different sizes, fibers having a certain size can help improve the mechanical properties of the resulting polymer composition. The inorganic fibers may, for example, have a nominal diameter of from about 5 micrometers to about 40 micrometers, in some embodiments from about 6 micrometers to about 30 micrometers, in some embodiments from about 8 micrometers to about 20 micrometers, and in some embodiments from about 9 micrometers to about 15 micrometers. The fibers (after compounding) may also have a relatively high aspect ratio (average length (μm) divided by nominal diameter (μm)), such as about 2 or more, in some embodiments from about 4 to about 100, in some embodiments from about 5 to about 50, and in some embodiments, from about 8 to about 40 are particularly beneficial. Such fibers may, for instance, have a volume average length (after compounding) of about 10 micrometers or more, in some embodiments about 25 micrometers or more, in some embodiments from about 50 micrometers or more to about 800 micrometers or less, and in some embodiments from about 60 micrometers to about 500 micrometers. The relative amount of the fibers may also be selectively controlled to help achieve the desired mechanical and thermal properties without adversely impacting other properties of the composition, such as its flowability. The inorganic fibers may, for instance, constitute from about 30 to about 120 parts by weight, in some embodiments from about 40 to about 110 parts by weight, and in some embodiments, from about 50 to about 100 parts by weight per 100 parts by weight of the polymer matrix. For example, the inorganic fibers may constitute from about 20 wt. % to about 60 wt. %, in some embodiments from about 25 wt. % to about 55 wt. %, and in some embodiments, from about 30 wt. % to about 50 wt. % of the polymer composition.

In addition to the size, strength, and relative concentration, the composition of the inorganic fibers may also be selectively controlled to achieve better hydrolytic stability at high temperatures. Generally speaking, the inorganic fibers may be formed from materials that are generally insulative in nature, such as glass, ceramics (e.g., alumina or silica), etc. Glass fibers are particularly suitable, such as E-glass, E-CR glass, A-glass, C-glass, D-glass, AR-glass, R-glass, S1-glass, S2-glass, etc., as well as mixtures of any of the foregoing. Glass fibers that are generally free of boron (e.g., E-CR glass fibers) are particularly suitable. In certain embodiments, the glass fibers may include silica (SiO₂), alumina (Al₂O₃), and oxides of calcium and magnesium (e.g., CaO, MgO, etc.), but are generally free of boron and optionally fluorides. For example, the glass fibers may contain boron in a concentration of about 1 wt. % or less, in some embodiments about 0.5 wt. % or less, in some embodiment about 0.1 wt. % or less (e.g., 0 wt. %), relative to the total weight of the glass fibers. The glass fibers may likewise contain fluorides in a concentration of about 0.5 wt. % or less, in some embodiments about 0.2 wt. % or less, in some embodiment about 0.01 wt. % or less (e.g., 0 wt. %), relative to the total weight of the glass fibers. Boron concentration and fluoride concentration can be measured by inductively coupled plasma-atomic emission spectrometry. In the absence of boric oxide, the glass fibers may further include titanium dioxide (TiO₂) to reduce melt viscosity. For example, the concentration of titanium in the glass fibers may be about 0.1 wt. % to about 1 wt. %, and in some embodiments, from about 0.15 wt. % to about 0.5 wt. % of the total weight of the glass fibers. Besides titanium dioxide, the glass fibers can further include potassium oxide (K₂O) and/or lithium oxide (Li₂O) as fluxing agents. For example, the concentration of potassium in the glass fibers may be about 0.2 wt. % to about 1 wt. %, and in some embodiments, from about 0.3 wt. % to about 0.5 wt. % of the total weight of the glass fibers. The concentration of lithium in the glass fibers may also be about 0.1 wt. % to about 1 wt. %, and in some embodiments, from about 0.2 wt. % to about 0.5 wt. % of the total weight of the glass fibers. The glass fibers may also have a relatively low amount of sodium oxide (Na₂O). For example, the concentration of sodium in the glass fibers may be about 0.1 wt. % to about 1 wt. %, and in some embodiments, from about 0.2 wt. % to about 0.5 wt. % of the total weight of the glass fibers. Titanium, potassium, lithium, and sodium concentrations can be measured by ICP-AES. In one particular embodiment, the glass fibers may contain silica in an amount of from about 57.5 wt. % to about 59.5 wt. %, alumina in an amount of from about 17 wt. % to about 20 wt. %, calcium oxide in an amount of from about 11 wt. % to about 13.5 wt. %, magnesium oxide in an amount of from about 8.5 wt. % to about 12.5 wt. %, and optionally sodium oxide, potassium oxide, lithium oxide, and/or titanium oxide. Other oxides may also be employed, such as iron oxide (Fe₂O₃).

If desired, the inorganic fibers may contain a sizing composition coated thereon to help improve hydrolytic resistance. The sizing composition may include an organosilane compound that is capable of forming Si—O—Si covalent bonds between the glass fiber surface and silanols obtained by hydrolysis of the silane compound, as well as between adjacent silanol groups. The resulting covalent bonds forms a crosslinked structure at the surface of the fibers that can enhance resistance to hydrolysis. Such organosilane compounds may, for instance, constitute from about 2 wt. % to about 40 wt. %, in some embodiments from about 2.5 wt. % to about 20 wt. %, and in some embodiments, from about 5 wt. to about 15 wt. % of the solids content of the sizing composition (i.e., excluding water). The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,

wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth; and
R⁶ is an alkoxy group of from 1 to 10 carbon atoms, such as methoxy, ethoxy, propoxy, and so forth.

Aminosilane compounds are particularly suitable and may include monomeric or oligomeric (<6 units) silanes. Aminotrialkoxysilanes may be employed in certain embodiments to form a three dimensional network of Si—O—Si covalent bonds at the surface and around the surface of the fibers. Aminodialkoxysilanes may likewise be employed in certain embodiments to form a hairlike structure on the surface of the fibers. While not necessarily forming a three-dimensional crosslinked protective sheath around the fibers, the dialkoxysilanes may nevertheless facilitate impregnation of the fiber bundles and wetting of the individual fibers by a polymer melt, as well as reduce the hydrophilicity of the surface of the fibers believed to contribute to resistance to hydrolysis. Thus, it may be desirable to employ trialkoxysilanes, dialkoxysilanes, or mixtures thereof in the sizing composition. Specific examples of suitable aminosilanes may include, for instance, aminodialkoxysilanes, such as γ-aminopropylmethyldiethoxysilane, N-β-(Aminoethyl)-gamma-aminopropylmethyldimethoxysilane, N-β-(Aminoethyl)-γ-aminopropyl-methyldimethoxysilane, N-β-(Aminoethyl)-γ-aminoisobutylmethyldimethoxy-silane, γ-aminopropylmethyldimethoxysilane, N-β-(Aminoethyl)-γ-aminopropyl-methyldiethoxysilane, etc.; aminotrialkoxysilanes, such as γ-aminopropyltriethoxysilane, γ-aminopropyltri-methoxysilane, N-β-(Aminoethyl)-γ-aminopropyl-trimethoxysilane, N-β-(Aminoethyl)-γ-aminopropyltriethoxysilane, diethylene-triaminopropyltrimethoxysilane, Bis-(γ-trimethoxysilylpropyl) amine, N-phenyl-γ-aminopropyltrimethoxysilane, γ-amino-3,3-dimethylbutyltrimethoxysilane, γ-aminobutyltriethoxysilane, etc.; as well as mixtures of any of the foregoing.

In addition to an organosilane compound, the sizing composition may also contain one or more functionalized compounds that may be crosslinked to form a three-dimensional polymer network that can further enhance the hydrolytic resistance of the fibers. When employed, such functionalized compounds may constitute from about 5 wt. % to about 90 wt. %, in some embodiments from about 10 wt. % to about 80 wt. %, and in some embodiments, from about 15 wt. to about 70 wt. % of the solids content of the sizing composition (i.e., excluding water). In one embodiment, for instance, the functionalized compound may be a blocked isocyanate. As used herein, the term “blocked isocyanate” refers to an isocyanate in which one or more of the isocyanate groups of an organic polyisocyanate have been reversibly reacted with a blocking agent. In this manner, the resulting blocked (partially or fully) isocyanate groups are stable to active hydrogens at ambient temperature but can become deblocked at elevated temperatures so that they are reactive with active hydrogens, such as, for example, at temperatures between about 90° C. to about 210° C., in some embodiments between about 105° C. to about 180° C., and in some embodiments, between about 125° C. to about 170° C. Representative examples of suitable organic polyisocyanates include aliphatic isocyanates (e.g., trimethylene diisocyanate, tetramethylene diisocyanate, hexamethylene diisocyanate, butylidene diisocyanate, etc.); (cyclo)aliphatic isocyanates (e.g., isophorone diisocyanate (IPDI), 4,4′-diisocyanato-dicyclohexylmethane (HMDI), etc.); aromatic isocyanates (e.g., p-phenylene diisocyanate); aliphatic-aromatic isocyanates (e.g., 4,4′-diphenylene methane diisocyanate, 2,4- or 2,6-tolylene diisocyanate, etc.); as well as mixtures thereof. Representative examples of suitable blocking agents include, but are not limited to, oximes, such as methyl ethyl ketoxime, acetone oxime and cyclohexanone oxime; lactams, such as epsilon-caprolactam; alcohols; malonic esters; alkyl acetoacetates, triazoles; pyrazoles; phenols; amines, such as benzyl t-butylamine; as well as mixtures thereof. In one embodiment, the blocked isocyanate is a blocked cycloaliphatic polyisocyanate.

The functionalized compound may also include polymers that contain an anhydride and/or carboxylic functionality. Examples of such polymers may include, for instance, a copolymer of ethylene-maleic anhydride, butadiene-maleic anhydride, isobutylene-maleic anhydride acrylate-maleic anhydride, polyacrylic acid, etc. When employed, such anhydride- and/or carboxylic-functionalized polymers may constitute from about 5 wt. % to about 60 wt. %, in some embodiments from about 10 wt. % to about 40 wt. %, and in some embodiments, from about 15 wt. to about 30 wt. % of the solids content of the sizing composition (i.e., excluding water). Other functionalized polymers may also be employed, either alone or in combination with polymers that contain an anhydride and/or carboxylic functionality. In certain embodiments, for example, an epoxy-functionalized polymer may be employed, such as epoxy phenol novolac (EPN), epoxy cresol novolac (ECN), etc. When employed, such epoxy-functionalized polymers may constitute from about 30 wt. % to about 90 wt. %, in some embodiments from about 40 wt. % to about 80 wt. %, and in some embodiments, from about 50 wt. to about 70 wt. % of the solids content of the sizing composition (i.e., excluding water). In certain embodiments, combinations of such functionalized polymers may also be employed. In fact, it is believed that a dense crosslinked sheath can formed around the inorganic fibers by reaction of epoxy groups with maleic anhydride and/or carboxylic groups.

Apart from organosilane and functionalized compounds, the sizing composition may also contain a film-forming agent that can help protect the fibers from damage during processing and promote compatibility of the fibers with the polymer matrix. Particularly suitable film forming agents are polymers, such as polyurethanes, (meth)acrylate polymers, epoxy resin emulsions (e.g., based on epoxy bisphenol A or epoxy bisphenol F), epoxy ester resins, epoxy urethane resins, polyamides, etc., as well as mixtures of any of the foregoing. In one particular embodiment, for example, the film forming agent may include a polymer that is also functionalized, such as a polymer that includes a blocked isocyanate functionality as described above. Examples of such functionalized film-forming agents may include polyester-based and polyether-based polyurethanes that include a blocked isocyanate. When employed, such film forming agents may constitute from about 0.1 wt. % to about 50 wt. %, in some embodiments from about 1 wt. % to about 40 wt. %, and in some embodiments, from about 5 wt. to about 30 wt. % of the solids content of the sizing composition (i.e., excluding water). Other additives may also be employed in the sizing composition, such as pH adjusters, lubricants, antistatic agents, antifoaming agents, crosslinking agents, etc.

The sizing composition may be applied to the surface of the inorganic fibers in a variety of different ways. For example, the sizing composition may be applied as the fibers are formed out of a bushing. The entire composition may also be applied to the fibers in a single step, or one or more components of the sizing composition may be applied separately. In one embodiment, for example, a two-stage application process may be employed in which a polymer containing an anhydride and/or carboxylic acid functionality is applied in a first stage and a polymer containing an epoxy functionality is applied in a second stage. In this manner, the polymers may be crosslinked together only after application to the fiber surface. Other components of the sizing composition may be applied separately or in combination with one or both of the polymers. Notwithstanding the particular process employed, one or more solvents (e.g., water) may be added to the components of the sizing composition during application to aid in the coating process. Once coated, the fibers may be dried to remove the solvent. In this regard, the moisture content of the coated fibers is typically about 0.5 wt. % or less, in some embodiments about 0.2 wt. % or less, and in some embodiments about 0.1 wt. % or less. Likewise, the amount of the sizing composition employed is typically from about 0.3 wt. % to about 1.2 wt. %, in some embodiments from about 0.4 wt. % to about 1 wt. %, and in some embodiments, from about 0.5 wt. % to about 0.8 wt. % based on the total weight of the coated fibers.

### C. Optional Components

In addition to the components noted above, the polymer composition may also contain a variety of other optional components to help improve its overall properties, such as flame retardants, heat stabilizers, light stabilizers, antioxidants, UV stabilizers, electromagnetic interference (“EMI”) fillers, coupling agents, impact modifiers, pigments (e.g., black pigments), laser marking additives (e.g., carbon black), lubricants, flow promoters, hydrolytically-resistant additives, and other materials added to enhance properties and processability.

In certain embodiments, for instance, it may be desired to employ a flame retardant system. When employed, the flame retardant system may constitute from about 5 wt. % to about 60 wt. %, in some embodiments from about 6 wt. % to about 50 wt. %, in some embodiments from about 8 wt. % to about 35 wt. %, and in some embodiments, from about 10 wt. % to about 30 wt. % of the polymer matrix, as well as from about 1 wt. % to about 50 wt. %, in some embodiments from about 5 wt. % to about 30 wt. %, and in some embodiments, from about 10 wt. % to about 25 wt. % of the entire polymer composition. The flame retardant system may include at least one low halogen or halogen-free flame retardant. The halogen (e.g., bromine, chlorine, and/or fluorine) content of such an agent is about 1,500 parts per million by weight (“ppm”) or less, in some embodiments about 900 ppm or less, and in some embodiments, about 50 ppm or less. In certain embodiments, the flame retardants are complete free of halogens (i.e., 0 ppm). The specific nature of the halogen-free flame retardants may be selected to help achieve the desired flammability properties without adversely impacting the dielectric performance (e.g., dielectric constant, dissipation factor, etc.) and mechanical properties of the polymer composition.

The flame retardant system may, for instance, contain one or more organophosphorous flame retardant compounds, such as phosphate salts, phosphoric acid esters, phosphonic acid esters, phosphonate amines, phosphazenes, phosphinic salts, etc., as well mixtures thereof. Organophosphorous flame retardant compounds may, for instance, constitute from about 40 wt. % to 100 wt. %, in some embodiments from about 50 wt. % to about 95 wt. %, and in some embodiments, from about 60 wt. % to about 90 wt. % of the flame retardant system. In certain embodiments, for instance, organophosphorous flame retardants may constitute from about 1 wt. % to about 25 wt. %, in some embodiments from about 5 wt. % to about 20 wt. %, and in some embodiments, from about 10 wt. % to about 15 wt. % of the entire polymer composition. One particularly suitable organophosphorous flame retardant may be a phosphinate, which can enhance the flame retardancy of the overall composition, particularly for relatively thin parts, without adversely impacting mechanical and insulative properties. Such phosphinates are typically salts of a phosphinic acid and/or diphosphinic acid, such as those having the general formula (I) and/or formula (II):

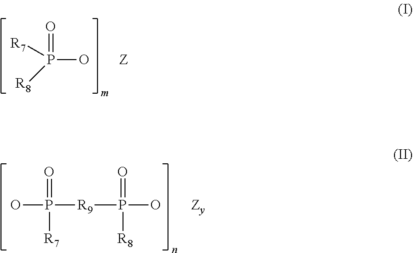

wherein,
R₇ and R₈ are, independently, hydrogen or substituted or unsubstituted, straight chain, branched, or cyclic hydrocarbon groups (e.g., alkyl, alkenyl, alkylnyl, aralkyl, aryl, alkaryl, etc.) having 1 to 6 carbon atoms, particularly alkyl groups having 1 to 4 carbon atoms, such as methyl, ethyl, n-propyl, iso-propyl, n-butyl, or tert-butyl groups;
R₉ is a substituted or unsubstituted, straight chain, branched, or cyclic C₁-C₁₀ alkylene, arylene, arylalkylene, or alkylarylene group, such as a methylene, ethylene, n-propylene, iso-propylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, t-butylnaphthylene, phenylethylene, phenylpropylene or phenylbutylene group;
Z is Mg, Ca, Al, Sb, Sn, Ge, Ti, Zn, Fe, Zr, Ce, Bi, Sr, Mn, Li, Na, K, and/or a protonated nitrogen base;
y is from 1 to 4, and preferably 1 to 2 (e.g., 1);
n is from 1 to 4, and preferably 1 to 2 (e.g. 1); and
m is from 1 to 4 and preferably 1 to 2 (e.g., 2).

The phosphinates may be prepared using any known technique, such as by reacting a phosphinic acid with a metal carbonate, metal hydroxide, or metal oxides in aqueous solution. Particularly suitable phosphinates include, for example, metal salts of dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid, hypophosphoric acid, etc. The resulting salts are typically monomeric compounds; however, polymeric phosphinates may also be formed. Particularly suitable metals for the salts may include Al and Zn. For instance, one particularly suitable phosphinate is zinc diethylphosphinate. Another particularly suitable phosphinate is aluminum diethylphosphinate, such as commercially available from Clariant under the name DEPAL™.

Of course, other organophosphorous flame retardants may also be employed in the flame retardant system. For example, in one embodiment, mono- and oligomeric phosphoric and phosphonic esters may be employed, such as tributyl phosphate, triphenyl phosphate, tricresyl phosphate, diphenyl cresyl phosphate, diphenyl octyl phosphate, diphenyl 2-ethylcresyl phosphate, tri(isopropylphenyl) phosphate, resorcinol-bridged oligophosphate, bisphenol A phosphates (e.g., bisphenol A-bridged oligophosphate or bisphenol A bis(diphenyl phosphate)), etc., as well as mixtures thereof. Aryl phosphates, aryl phosphonites, aryl phosphonates, hypophosphorous acid salts, etc.; phosphazenes; red phosphorous; etc., may also be employed as suitable organophorphorous flame retardants.

Besides organophosphorous flame retardants, the flame retardant system may also contain a variety of other components. For example, in certain embodiments, the flame retardant system may include one or more organophosphorous synergists. The halogen (e.g., bromine, chlorine, and/or fluorine) content of such a synergist is typically about 1,500 parts per million by weight (“ppm”) or less, in some embodiments about 900 ppm or less, and in some embodiments, about 50 ppm or less. In certain embodiments, the synergists are complete free of halogens (i.e., 0 ppm). When employed, such organophosphorous synergists typically constitute from about 5 wt. % to about 50 wt. %, in some embodiments from about 15 wt. % to about 45 wt. %, and in some embodiments, from about 20 wt. % to about 40 wt. % of the flame retardant system. In certain embodiments, for instance, organophosphorous synergists may constitute from about 0.1 wt. % to about 20 wt. %, in some embodiments from about 0.5 wt. % to about 15 wt. %, and in some embodiments, from about 1 wt. % to about 10 wt. % of the entire polymer composition. Examples of suitable organophosphorus synergists may include, for instance, salts of phosphorous acid, such as phosphates, hydrogen phosphates, orthophosphates, pyrophosphates, phosphonites, phosphites, phosphonates, etc., as well as combination thereof.

The cation used to form the salts of phosphorous acid may be a metal cation (e.g., Mg, Ca, Al, Sb, Sn, Ge, Ti, Zn, Fe, Zr, Ce, Bi, Sr, Mn, Li, Na, K, etc., as well as combinations thereof); protonated nitrogen base(s); or combinations of any of the foregoing (e.g., combination of a metal and protonated nitrogen base). When employing a metal cation, aluminum and zinc are particularly suitable, such as aluminum phosphite, zinc phosphite, aluminum phosphonate, zinc phoshonate, calcium phosphate, aluminum phosphate, zinc phosphate, titanium phosphate, iron phosphate, calcium hydrogenphosphate, calcium hydrogenphosphate dihydrate, magnesium hydrogenphosphate, titanium hydrogenphosphate, zinc hydrogenphosphate, aluminum phosphate, aluminum orthophosphate, aluminum hydrogenphosphate, aluminum dihydrogenphosphate, magnesium dihydrogenphosphate, calcium dihydrogenphosphate, zinc dihydrogenphosphate, zinc dihydrogenphosphate dihydrate, aluminum dihydrogenphosphate, calcium pyrophosphate, calcium dihydrogenpyrophosphate, magnesium pyrophosphate, zinc pyrophosphate aluminum pyrophosphate, etc., as well as blends thereof. Suitable protonated nitrogen bases may likewise include those having a substituted or unsubstituted ring structure, along with at least one nitrogen heteroatom in the ring structure (e.g., heterocyclic or heteroaryl group) and/or at least one nitrogen-containing functional group (e.g., amino, acylamino, etc.) substituted at a carbon atom and/or a heteroatom of the ring structure. Examples of such heterocyclic groups may include, for instance, pyrrolidine, imidazoline, pyrazolidine, oxazolidine, isoxazolidine, thiazolidine, isothiazolidine, piperidine, piperazine, thiomorpholine, etc. Likewise, examples of heteroaryl groups may include, for instance, pyrrole, imidazole, pyrazole, oxazole, isoxazole, thiazole, isothiazole, triazole, furazan, oxadiazole, tetrazole, pyridine, diazine, oxazine, triazine, tetrazine, and so forth. If desired, the ring structure of the base may also be substituted with one or more functional groups, such as acyl, acyloxy, acylamino, alkoxy, alkenyl, alkyl, amino, aryl, aryloxy, carboxyl, carboxyl ester, cycloalkyl, hydroxyl, halo, haloalkyl, heteroaryl, heterocyclyl, etc. Substitution may occur at a heteroatom and/or a carbon atom of the ring structure. One suitable nitrogen base is melamine, which contains a 1,3,5 triazine ring structure substituted with an amino functional group at each of the three carbon atoms. Another suitable nitrogen base is piperazine, which is a six-membered ring structure containing two nitrogen atoms at opposite positions in the ring.

In one particular embodiment, the organophosphorous synergist may be a salt containing only a protonated nitrogen base cation, such as an azine (e.g., melamine and/or piperazine) phosphate salt. Examples of such azine phosphate salts may include, for instance, melamine orthophosphate, melamine pyrophosphate, melamine polyphosphate, piperazine orthophosphate, piperazine pyrophosphate, piperazine polyphosphate, etc., as well as blends thereof. Melamine polyphosphate may, for instance, be those commercially available from BASF under the name MELAPUR® (e.g., MELAPUR® 200 or 200/70). In another embodiment, the organophosphorous synergist may be a salt containing a combination of a metal cation and a protonated nitrogen base cation, such as an azine (e.g., melamine and/or piperazine) metal phosphate salt. Examples of suitable azine metal phosphate salts may include, for instance, melamine zinc phosphate, melamine magnesium phosphate, melamine calcium phosphate, bismelamine zincodiphosphate, bismelamine aluminotriphosphate, (melamine)₂Mg(HPO₄)₂, (melamine)₂Ca(HPO₄)₂, (melamine)₃Al(HPO₄)₃, (melamine)₂Mg(P₂O₇), (melamine)₂Ca(P₂O₇), (melamine)₂Zn(P₂O₇), (melamine)₃Al(P₂O₇)_{3/2}, etc., as well as blends thereof. Azine poly(metal phosphates) may also be employed that are known as hydrogenphosphato- or pyrophosphatometalates with complex anions having a tetra- or hexavalent metal atom as coordination site with bidentate hydrogenphosphate or pyrophosphate ligands. Examples of such poly(metal phosphates) may include, for instance, melamine poly(zinc phosphate) and/or melamine poly(magnesium phosphate).

The flame retardant system may be formed entirely of organophosphorous flame retardants and/or synergists, such as those described above. In certain embodiments, however, it may be desired to employ additional compounds to help increase the effectiveness of the system. For example, inorganic compounds may be employed as low halogen char-forming agents and/or smoke suppressants in combination with organophosphorous compound(s). Suitable inorganic compounds (anhydrous or hydrates) may include, for instance, inorganic molybdates, such as zinc molybdate (e.g., commercially available under the designation Kemgard® from Huber Engineered Materials), calcium molybdate, ammonium octamolybdate, zinc molybdate-magnesium silicate, etc. Other suitable inorganic compounds may include inorganic borates, such as zinc borate (commercially available under the designation Firebrake® from Rio Tento Minerals), etc.); basic zinc chromate (VI) (zinc yellow), zinc chromite, zinc permanganate, silica, magnesium silicate, calcium silicate, calcium carbonate, titanium dioxide, magnesium dihydroxide, and so forth. In particular embodiments, it may be desired to use an inorganic zinc compound, such as zinc molybdate, zinc borate, etc., to enhance the overall performance of the composition. When employed, such inorganic compounds (e.g., zinc borate) may, for example, constitute from about 1 wt. % to about 20 wt. %, in some embodiments from about 2 wt. % to about 15 wt. %, and in some embodiments, from about 3 wt. % to about 10 wt. % of the flame retardant system, and also from about 0.1 wt. % to about 10 wt. %, in some embodiments from about 0.2 wt. % to about 5 wt. %, and in some embodiments, from about 0.5 wt. % to about 4 wt. % of the entire polymer composition.

The flame retardant system and/or the polymer composition itself generally has a relatively low content of halogens (i.e., bromine, fluorine, and/or chlorine), such as about 15,000 parts per million (“ppm”) or less, in some embodiments about 10,000 ppm or less, in some embodiments about 5,000 ppm or less, in some embodiments about 200 ppm or less, and in some embodiments, from about 1 ppm to about 1,500 ppm. Nevertheless, in certain embodiments of the present invention, halogen-based flame retardants may still be employed as an optional component. Particularly suitable halogen-based flame retardants are fluoropolymers, such as polytetrafluoroethylene (PTFE), fluorinated ethylene polypropylene (FEP) copolymers, perfluoroalkoxy (PFA) resins, polychlorotrifluoroethylene (PCTFE) copolymers, ethylene-chlorotrifluoroethylene (ECTFE) copolymers, ethylene-tetrafluoroethylene (ETFE) copolymers, polyvinylidene fluoride (PVDF), polyvinylfluoride (PVF), and copolymers and blends and other combination thereof. When employed, such halogen-based flame retardants typically constitute only about 10 wt. % or less, in some embodiments about 5 wt. % or less, and in some embodiments, about 1 wt. % or less of the flame retardant system. Likewise, the halogen-based flame retardants typically constitute about 5 wt. % or less, in some embodiments about 1 wt. % or less, and in some embodiments, about 0.5 wt. % or less of the entire polymer composition.

If desired, the polymer matrix may also contain a stabilizer system to help maintain the desired surface appearance and/or mechanical properties even after being exposed to ultraviolet light and high temperatures. When employed, the stabilizer system may constitute from about 0.1 wt. % to about 5 wt. %, in some embodiments from about 0.2 wt. % to about 4 wt. %, and in some embodiments, from about 0.4 wt. % to about 3 wt. % of the composition.

The stabilizer system may include, for example, one or more antioxidants (e.g., sterically hindered phenol antioxidant, phosphite antioxidant, phosphonite antioxidant, thioester antioxidant, etc.), UV stabilizers, light stabilizers, heat stabilizers, etc., as well as combinations thereof. In one embodiment, for example, the stabilizer system may contain a light stabilizer. For example, the stabilizer may include a hindered amine light stabilizer. When employed, such light stabilizers may constitute from about 0.001 wt. % to about 1 wt. %, in some embodiments from about 0.01 wt. % to about 0.5 wt. %, and in some embodiments, from about 0.05 wt. % to about 0.3 wt. % of the entire polymer composition. The hindered amine light stabilizer may, for example, contain one or more compounds of the following general structures:

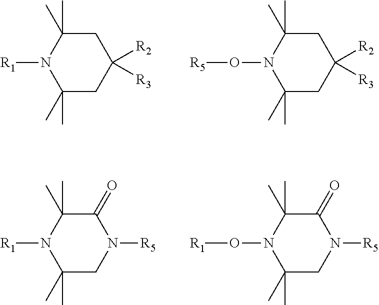

wherein,
R₁, R₂, R₃, and R₅ are independently hydrogen, ether groups, ester groups, amine groups, amide groups, alkyl groups, alkenyl groups, alkynyl groups, aralkyl groups, cycloalkyl groups and aryl groups, in which the substituents in turn may contain functional groups; examples of functional groups are alcohols, ketones, anhydrides, imines, siloxanes, ethers, carboxyl groups, aldehydes, esters, amides, imides, amines, nitriles, ethers, urethanes, or any combination thereof.

In certain embodiments, the hindered amine light stabilizer includes a substituted piperidine compound, such as an alkyl-substituted piperidyl, piperidinyl or piperazinone compound, and substituted alkoxypiperidinyl compounds. Examples of such compounds may include, for instance, N,N′-bis(2,2,6,6-tetramethyl-4-piperdiyl)-1,3-benzenedicarboxamide (Nylostab® S-EED); 2,2,6,6-tetramethyl-4-piperidone; 2,2,6,6-tetramethyl-4-piperidinol; bis-(1,2,2,6,6-pentamethyl piperidyl)-(3′,5′-di-tert-butyl-4′-hydroxybenzyl) butylmalonate; di-(2,2,6,6-tetramethyl-4-piperidyl) sebacate (Tinuvin® 770); oligomer of N-(2-hydroxyethyl)-2,2,6,6-tetramethyl-4-piperidinol and succinic acid (Tinuvin® 622); oligomer of cyanuric acid and N,N-di(2,2,6,6-tetramethyl-4-piperidyl)-hexamethylene diamine; bis-(2,2,6,6-tetramethyl-4-piperidinyl) succinate; bis-(1-octyloxy-2,2,6,6-tetramethyl-4-piperidinyl) sebacate (Tinuvin® 123); bis-(1,2,2,6,6-pentamethyl-4-piperidinyl) sebacate (Tinuvin® 765); tetrakis-(2,2,6,6-tetramethyl-4-piperidyl)-1,2,3,4-butane tetracarboxylate; N,N′-bis-(2,2,6,6-tetramethyl-4-piperidyl)-hexane-1,6-diamine (Chimasorb® T5); N-butyl-2,2,6,6-tetramethyl-4-piperidinarine; 2,2′-[(2,2,6,6-tetramethyl-piperidinyl)-imino]-bis-[ethanol]; poly((6-morpholine-5-triazine-2,4-diyl)(2,2,6,6-tetramethyl-4-piperidinyl)-iminohexarethylene-(2,2,6,6-tetramethyl-4-piperidinyl)-imino) (Cyasorb® UV 3346); 5-(2,2,6,6-tetramethyl-4-piperidinyl)-2-cyclo-undecyl-oxazole) (Hostavin® N20); 1,1′-(1,2-ethane-di-yl)-bis-(3,3′,5,5′-tetramethyl-piperazinone); polymethylpropyl-3-oxy-[4(2,2,6,6-tetramethyl)-piperidinyl]siloxane (Uvasil® 299); 1,2,3,4-butane-tetracarboxylic acid-1,2,3-tris(1,2,2,6,6-pentamethyl-4-piperidinyl)-4-tridecylester; copolymer of alpha-methylstyrene-N-(2,2,6,6-tetramethyl-4-piperidinyl) maleimide and N-stearyl maleimide; D-glucitol, 1,3:2,4-bis-O-(2,2,6,6-tetramethyl-4-piperidinylidene)-(HALS 7); oligomer of 7-oxa-3,20-diazadispiro[5.1.11.2]-heneicosan-21-one-2,2,4,4-tetramethy-I-20-(oxiranylmethyl) (Hostavin® N30); propanedioic acid, [(4-methoxyphenyl)methylene]-,bis(1,2,2,6,6-pentamethyl-4-piperidinyl) ester (Sanduvor® PR 31); formamide, N,N′-1,6-hexanediylbis[N-(2,2,6,6-tetramethyl-4-piperidinyl (Uvinul® 4050H); 1,3,5-triazine-2,4,6-triarine, N,N′″-[1,2-ethanediylbis[[[4,6-bis[butyl(1,2,2,6,6-pentamethyl-4-piperidinyl)amino]-1,3,5-triazine-2-yl]imino]-3,1-propanediyl]]-bis[N′,N″-dibuty-I-N′,N″-bis(1,2,2,6,6-pentamethyl-4-piperidinyl) (Chimassorb® 119 MW 2286); poly[[6-[(1,1,3,33-tetramethylbutyl)amino]-1,3,5-triazine-2,4-diyl][(2,2,6,6-tetramethyl-4-piperidinyl)-imino]-1,6-hexanediyl[(2,2,6,6-tetramethyl-4-piperidinyl)imino]] (Chimassorb® 944 MW 2000-3000); 1,5-dioxaspiro(5,5) undecane 3,3-dicarboxylic acid, bis(2,2,6,6-tetramethyl-4-piperidinyl) ester (Cyasorb® UV-500); 1,5-dioxaspiro(5,5) undecane 3,3-dicarboxylic acid, bis(1,2,2,6,6-pentamethyl-4-piperidinyl)ester (Cyasorb® UV-516); N-2,2,6,6-tetramethyl-4-piperidinyl-N-amino-oxamide; 4-acryloyloxy-1,2,2,6,6-pentamethyl-4-piperidine; 1,5,8,12-tetrakis[2′,4′-bis(1″,2″,2″,6″,6″-pentamethyl-4″-piperidin-yl(butyl)amino)-1′,3′,5′-triazine-6′-yl]-1,5,8,12-tetraazadodecane; 3-dodecyl-1-(2,2,6,6-tetramethyl-4-piperidyl)-pyrrolidin-2,5-dione; 1,1′-(1,2-ethane-di-yl)-bis-(3,3′,5,5′-tetra-methyl-piperazinone) (Goodrite® 3034); 1,1,′1″-(1,3,5-triazine-2,4,6-triyltris((cyclohexylimino)-2,1-ethanediyl)tris(3,3,5,5-tetramethylpiperazinone) (Goodrite® 3150); 1,1′,1″-(1,3,5-triazine-2,4,6-triyltris((cyclohexylimino)-2,1-ethanediyl)tris(3,3,4,5,5-tetramethylpiperazinone) (Goodrite® 3159); and so forth.

In one particular embodiment, the hindered amine light stabilizer includes an alkyl-substituted piperidyl compound. For example, the compound may be a di- or tri-carboxylic (ester) amide, such as N,N′-bis(2,2,6,6-tetramethyl-4-piperdiyl)-1,3-benzenedicarboxamide (Nylostab® S-EED).

Besides light stabilizers, the stabilizer system may also include an antioxidant. When employed, such antioxidants typically constitute from about 0.01 wt. % to about 1 wt. %, in some embodiments from about 0.05 wt. % to about 0.8 wt. %, and in some embodiments, from about 0.1 wt. % to about 0.5 wt. % of the entire polymer composition. One type of a suitable antioxidant is a sterically hindered phenolic antioxidant. Examples of such phenolic antioxidants include, for instance, calcium bis(ethyl 3,5-di-tert-butyl-4-hydroxybenzylphosphonate) (Irganox® 1425); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); phosphonic acid, (3,5-di-tert-butyl-4-hydroxybenzyl)-,dioctadecyl ester (Irganox® 1093); 1,3,5-trimethyl-2,4,6-tris(3′,5′-di-tert-butyl-4′hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 2,2′-ethylidenebis[4,6-di-tert-butylphenol] (Irganox® 129); N,N′-(hexane-1,6-diyl)bis[3-(3,5-di-tert-butyl-4-hydroxyphenyl)propanamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl] phosphite (Hostanox® OSP 1); tetrakis [methylene-(3,5-di-tertbutyl-4-hydroxycinnimate)]methane (Irganox® 1010); and ethylene-bis(oxyethylene)bis[3-(5-tert-butyl-4-hydroxy-m-tolyl)-propionate (Irganox® 245); and so forth.

Phosphorous-containing antioxidants may also be employed, such as phosphonites having the structure:

[R—P(OR₁)₂]ₘ (1)

wherein,
R is a mono- or polyvalent aliphatic, aromatic, or heteroaromatic organic radical, such as a cyclohexyl, phenyl, phenylene, and/or biphenyl radical; and
R₁ is independently a compound of the structure (II)

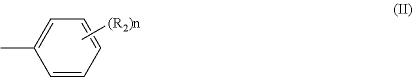

or the two radicals R₁ form a bridging group of the structure (III)

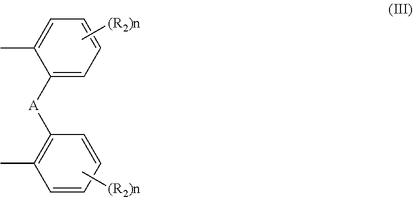

where
A is a direct bond, O, S, C₁₋₁₈ alkylene (linear or branched), or C₁₋₁₈ alkylidene (linear or branched);
R₂ is independently C₁₋₁₂ alkyl (linear or branched), C₁₋₁₂ alkoxy, or C₅₋₁₂ cycloalkyl;
n is from 0 to 5, in some embodiments from 1 to 4, and in some embodiments, from 2 to 3, and
m is from 1 to 4, in some embodiments from 1 to 3, and in some embodiments, from 1 to 2 (e.g., 2).

Particular preference is given to compounds which, on the basis of the preceding claims, are prepared via a Friedel-Crafts reaction of an aromatic or heteroaromatic system, such as benzene, biphenyl, or diphenyl ether, with phosphorus trihalides, preferably phosphorus trichloride, in the presence of a Friedel-Crafts catalyst, such as aluminum chloride, zinc chloride, iron chloride, etc., and a subsequent reaction with the phenols underlying the structures (II) and (Ill). Mixtures with phosphites produced in the specified reaction sequence from excess phosphorus trihalide and from the phenols described above are expressly also covered by the invention.

In one particular embodiment, R₁ is a group of the structure (II). Among this group of compounds, antioxidants of the general structure (V) are particularly suitable:

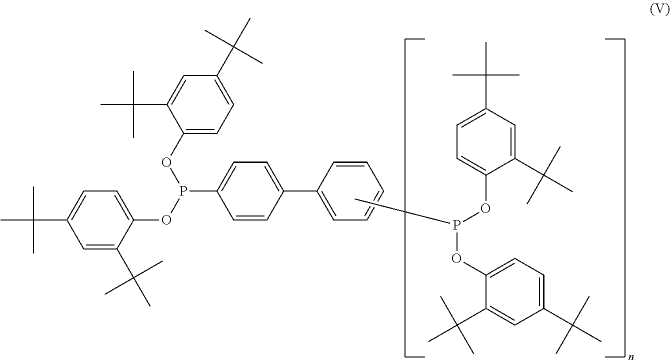

wherein, n is as defined above.

In one particular embodiment, for instance, n in formula (V) is 1 such that the antioxidant is tetrakis(2,4-di-tert-butylphenyl)4,4′-biphenylene-diphosphonite.

Another suitable phosphorous-containing antioxidant is a phosphite antioxidant. The phosphite antioxidant may include a variety of different compounds, such as aryl monophosphites, aryl disphosphites, etc., as well as mixtures thereof. For example, an aryl diphosphite may be employed that has the following general structure (IX):

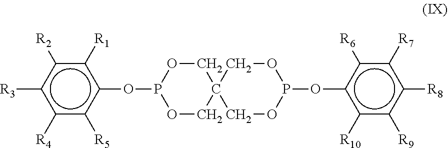

wherein,
R₁, R₂, R₃, R₄, R₅, R₆, R₇, R₈, R₉, and R₁₀ are independently selected from hydrogen, C₁ to C₁₀ alkyl, and C₃ to C₃₀ branched alkyl, such as methyl, ethyl, propyl, isopropyl, butyl, or tertiary butyl moieties.

Examples of such aryl diphosphite compounds include, for instance, bis(2,4-dicumylphenyl)pentaerythritol diphosphite (commercially available as Doverphos® S-9228) and bis(2,4-di-t-butylphenyl)pentaerythritol diphosphite (commercially available as Ultranox® 626). Likewise, suitable aryl monophosphites may include tris(2,4-di-tert-butylphenyl)phosphite (commercially available as Irgafos® 168); bis(2,4-di-tert-butyl-6-methylphenyl) ethyl phosphite (commercially available as Irgafos® 38); and so forth.

Yet another suitable antioxidant is a thioester antioxidant. Particularly suitable thioester antioxidants for use in the present invention are thiocarboxylic acid esters, such as those having the following general structure:

R₁₁—O(O)(CH₂)ₓS—(CH₂)_{y}(O)O—R₁₂

wherein,
x and y are independently from 1 to 10, in some embodiments 1 to 6, and in some embodiments, 2 to 4 (e.g., 2);
R₁₁ and R₁₂ are independently selected from linear or branched, C₆ to C₃₀ alkyl, in some embodiments C₁₀ to C₂₄ alkyl, and in some embodiments, C₁₂ to C₂₀ alkyl, such as lauryl, stearyl, octyl, hexyl, decyl, dodecyl, oleyl, etc.

Specific examples of suitable thiocarboxylic acid esters may include for instance, distearyl thiodipropionate (commercially available as Irganox® PS 800), 1,3-propanediylester; 3-laurylthiopropionate (commercially available as AO-412S), dilauryl thiodipropionate (commercially available as Irganox® PS 802), di-2-ethylhexyl-thiodipropionate, diisodecyl thiodipropionate, etc.

The polymer composition may also contain one or more UV stabilizers. Suitable UV stabilizers may include, for instance, benzophenones (e.g., (2-hydroxy-4-(octyloxy)phenyl)phenyl, methanone (Chimassorb® 81), benzotriazoles (e.g., 2-(2-hydroxy-3,5-di-α-cumylphenyl)-2H-benzotriazole (Tinuvin® 234), 2-(2-hydroxy-5-tert-octylphenyl)-2H-benzotriazole (Tinuvin® 329), 2-(2-hydroxy-3-α-cumyl-5-tert-octylphenyl)-2H-benzotriazole (Tinuvin® 928), etc.), triazines (e.g., 2,4-diphenyl-6-(2-hydroxy-4-hexyloxyphenyl)-s-triazine (Tinuvin® 1577)), sterically hindered amines (e.g., bis(2,2,6,6-tetramethyl-4-piperidyl)sebacate (Tinuvin® 770) or a polymer of dimethyl succinate and 1-(2-hydroxyethyl)-4-hydroxy-2,2,6,6-tetramethyl-4-piperidine (Tinuvin®622)), and so forth, as well as mixtures thereof. Benzophenones are particularly suitable for use in the polymer composition. When employed, such UV stabilizers typically constitute from about 0.05 wt. % to about 2 wt. % in some embodiments from about 0.1 wt. % to about 1.5 wt. %, and in some embodiments, from about 0.2 wt. % to about 1.0 wt. % of the composition.

In addition to the components noted above, the polymer matrix may also contain a variety of other components. When EMI shielding properties are desired, for instance, an EMI filler may be employed. The EMI filler is generally formed from an electrically conductive material that can provide the desired degree of electromagnetic interference shielding. In certain embodiments, for instance, the material contains a metal, such as stainless steel, aluminum, zinc, iron, copper, silver, nickel, gold, chrome, etc., as well alloys or mixtures thereof. The EMI filler may also possess a variety of different forms, such as particles (e.g., iron powder), flakes (e.g., aluminum flakes, stainless steel flakes, etc.), or fibers. Particularly suitable EMI fillers are fibers that contain a metal. In such embodiments, the fibers may be formed from primarily from the metal (e.g., stainless steel fibers) or the fibers may be formed from a core material that is coated with the metal. When employing a metal coating, the core material may be formed from a material that is either conductive or insulative in nature. For example, the core material may be formed from carbon, glass, or a polymer. One example of such a fiber is nickel-coated carbon fibers. In certain embodiments, for example, the resulting polymer composition may exhibit an EMI shielding effectiveness (“SE”) of about 40 decibels (dB) or more, in some embodiments about 45 dB or more, in some embodiments about 50 dB or more, and in some embodiments, from about 55 dB to about 200 dB, as determined in accordance with ASTM D4935-18 at a high frequency, such as 6 GHz. The EMI shielding effectiveness may remain stable over a high frequency range, such as about 700 MHz or more, in some embodiments from about 1 GHz to about 100 GHz, and in some embodiments, from about 2 GHz to about 18 GHz. The EMI shielding effectiveness may also be within the desired range for a variety of different part thicknesses, such as from about 0.5 to about 10 millimeters, in some embodiments from about 0.8 to about 5 millimeters, and in some embodiments, from about 1 to about 4 millimeters (e.g., 1 millimeter, 1.6 millimeters, or 3 millimeters). Within these high frequency and/or thickness ranges, for example, the average EMI shielding effectiveness may be about 40 dB or more, in some embodiments about 45 dB or more, and in some embodiments, from about 50 dB to about 200 dB. Likewise, the minimum EMI shielding effectiveness may be about 10 dB or more, in some embodiments about 15 dB or more, and in some embodiments, from about 20 dB to about 100 dB. The composition may also have good EMI shielding effectiveness at lower frequencies, such as from 200 MHz to 1.5 GHz. For example, within these lower frequency ranges and the thickness ranges noted above, the average EMI shielding effectiveness may be about 50 dB or more, in some embodiments about 55 dB or more, and in some embodiments, from about 60 dB to about 200 dB.

Other additives for improving the hydrolytic resistance of the polymer composition may also be employed. In one embodiment, for example, an epoxy component may be employed that is capable of reacting with an acid end group of the aromatic polyester and that has at least 2 epoxy functional groups per molecule of epoxy component. In one embodiment, the epoxy component may be at least one diphenolic epoxy condensation polymer, which is includes condensation polymers of epichlorohydrin with a diphenolic compound. Also preferred is a 2,2-bis(p-glycidy) (oxyphenyl) propane condensation product with 2,2-bis(p-hydroxyphenyl)propane and similar isomers. Commercially available diphenolic epoxy condensation polymers include the EPON® 1000 resin series, from Momentive Specialty Chemicals. Particularly suitable epoxy components contain at least two epoxy functional groups, in some embodiments at least three epoxy functional groups, and in some embodiments, at least four epoxy groups, per molecule of the epoxy component. The epoxy groups may contain glycidyl ethers, and even more preferably, glycidyl ethers of phenolic compounds. The epoxy components may be polymeric, oligomeric, or non-polymeric. An example of an epoxy component is a tetraglycidyl ether of tetra (parahydroxyphenyl)ethane. An example of a commercially available epoxy component is Araldite® ECN 1299, available from Advanced Materials, Basel Switzerland. Another example is EPON® 1031 available from Momentive Specialty Chemicals, Inc. Other epoxy components include epoxidized natural oils or fatty esters such as epoxidized soybean oil, epoxidized linseed/soybean oil, copolymers of styrene and glycidyl methacrylate, diglycidyl ethers of bisphenol A/bisphenol F, diglycidyl adducts of amines and amides, diglycidyl adducts of carboxylic acids, bis(3,4-epoxycyclohexylmethyl) adipate, vinylcyclohexene di-epoxide, epoxy phenol novolac and epoxy cresol novolac resins, epoxidized alkenes such as epoxidized alpha olefins, and epoxidized unsaturated fatty acids.

Impact modifiers may also be employed within the polymer composition. When employed, impact modifier(s) constitute from about 1 parts to about 50 parts, in some embodiments from about 2 to about 40 parts, and in some embodiments, from about 5 to about 30 parts by weight per 100 parts by weight of the polymer matrix. For example, the impact modifiers may constitute from about 0.1 wt. % to about 20 wt. %, in some embodiments from about 0.5 wt. % to about 15 wt. %, and in some embodiments, from about 1 wt. % to about 10 wt. % of the polymer composition.

To help impart the desired combination of softness, flexibility, and scratch resistance, the impact modifier may be a polymer that contains a (meth)acrylic component. As used herein, the term “(meth)acrylic” includes acrylic and methacrylic monomers, as well as salts or esters thereof, such as acrylate and methacrylate monomers. The (meth)acrylic component may, for example, constitute from about 5 wt. % to about 45 wt. %, in some embodiments from about 10 wt. % to about 42 wt. %, and in some embodiments, from about 20 wt. % to about 40 wt. % of the impact modifier.

The (meth)acrylic component may be derived from one or more types of monomeric components. In one embodiment, for example, the (meth)acrylic component may be derived entirely or in part from an “epoxy-functionalized” (meth)acrylic component. The term “epoxy-functionalized” generally means that the component contains, on average, two or more epoxy functional groups per molecule. For example, suitable epoxy-functionalized (meth)acrylic monomers may include, but are not limited to, those containing 1,2-epoxy groups, such as glycidyl acrylate and glycidyl methacrylate. Other suitable epoxy-functionalized monomers include allyl glycidyl ether, glycidyl ethacrylate, and glycidyl itoconate. When employed, the epoxy-functionalized (meth)acrylic monomer(s) typically constitute from about 1 wt. % to about 35 wt. %, in some embodiments from about 2 wt. % to about 20 wt. %, and in some embodiments, from about 4 wt. % to about 12 wt. % of the impact modifier.

Of course, (meth)acrylic monomer(s) may also be employed that are not epoxy-functionalized. Examples of such (meth)acrylic monomers may include methyl acrylate, ethyl acrylate, propyl acrylate (e.g., n-propyl acrylate, i-propyl acrylate, etc.), butyl acrylate (e.g., n-butyl acrylate, s-butyl acrylate, i-butyl acrylate, t-butyl acrylate, etc.), amyl acrylate (e.g., n-amyl acrylate, i-amyl acrylate, etc.), isobornyl acrylate, hexyl acrylate (e.g., n-hexyl acrylate), 2-ethylbutyl acrylate, 2-ethylhexyl acrylate, octyl acrylate (e.g., n-octyl acrylate), decyl acrylate (e.g., n-decyl acrylate), methylcyclohexyl acrylate, cyclopentyl acrylate, cyclohexyl acrylate, methyl methacrylate, ethyl methacrylate, 2-hydroxyethyl methacrylate, propyl methacrylate (e.g., n-propyl methacrylate, i-propyl methacrylate, etc.), butyl methacrylate (e.g., n-butyl methacrylate, i-butyl methacrylate, t-butyl methacrylate, etc.), amyl methacrylate (e.g., n-amyl methacrylate, i-amyl methacrylate, etc.), hexyl methacrylate (e.g., n-hexyl methacxrylate), 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. When employed, the non-epoxy-functionalized (meth)acrylic monomer(s) typically constitute from about 5 wt. % to about 40 wt. %, in some embodiments from about 10 wt. % to about 35 wt. %, and in some embodiments, from about 15 wt. % to about 30 wt. % of the impact modifier.

The impact modifier may also contain an olefinic monomeric unit that is derived from one or more α-olefins. When employed, such α-olefin monomer(s) typically constitute from about 50 wt. % to about 90 wt. %, in some embodiments from about 60 wt. % to about 85 wt. %, and in some embodiments, from about 65 wt. % to about 75 wt. % of the copolymer. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene.

In one particular embodiment, for example, the impact modifier may be a random copolymer of an olefinic monomer (e.g., ethylene) and an epoxy-functionalized (meth)acrylic monomer (e.g., glycidyl methacrylate) or non-epoxy-functionalized (meth)acrylic monomer. One commercially available example of such an impact modifier is Lotader® AX8840 (8 wt. % glycidyl methacrylate and 92 wt. % ethylene). In another embodiment, the impact modifier may be a terpolymer formed from an olefin monomer (e.g., ethylene), an epoxy-functionalized (meth)acrylic monomer (e.g., glycidyl methacrylate), and a non-epoxy functionalized (meth)acrylic monomer (e.g., butyl acrylate, methyl acrylate, butyl methacrylate, methyl methacrylate, etc.). Commercially available examples of such impact modifiers include Elvaloy® PTW (5 wt. % glycidyl methacrylate, 28 wt. % butyl acrylate, and 67 wt. % ethylene), Lotader® AX8900 (8 wt. % glycidyl methacrylate, 24 wt. % methyl acrylate, 68 wt. % ethylene), Lotader® AX8750 (5 wt. % glycidyl methacrylate, 25 wt. % butyl acrylate, and 70 wt. % ethylene), and Lotader® AX8750T (5 wt. % glycidyl methacrylate, 27 wt. % butyl acrylate, and 68 wt. % ethylene).

The resulting melt flow index of the impact modifier may vary, but is typically from about 1 to about 50 grams per 10 minutes (“g/10 min”), in some embodiments from about 2 to about 40 g/10 min, and in some embodiments, from about 3 to about 25 g/10 min, as determined in accordance with ISO 1133-1:2022 at a load of 2.16 kg and temperature of 190° C.

### II. Melt Processing

The manner in which the aromatic polyester, inorganic filler, and various other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 500 rpm or less, in one embodiment, such as between about 200 rpm and about 450 rpm, or between about 300 rpm and about 400 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

### III. Formed Component

A variety of different components may be formed using the polymer composition described herein. Moreover, a component may be formed from the polymer composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer composition for a desired time period to allow for solidification. The molded product may then be solidified by bringing it to a temperature below that of the melting temperature. The resulting product may be de-molded. The cycle time for each molding process may be adjusted to suit the polymer composition, to achieve sufficient bonding, and to enhance overall process productivity.

Although by no means required, the resulting component may be laser marked as is known in art. Laser marking may be performed by irradiating the component with a laser beam to decompose and sublime certain laser marking additives contained in the polymer composition, such as carbon black. Alternatively, a masking layer may be disposed between the light source and the molded article so that the laser beam reaches only the portion to be marked, and then the entire surface is irradiated with a laser beam. Examples of a usable laser beam may include a Nd:YAG laser or Nd:YVO4 laser. In laser marking, the irradiation conditions of the laser beam are not particularly limited and may be appropriately adjusted according to the concentration of the additive and the heat resistance of the resin contained in the material used for the target molded article. The irradiation conditions may be set so that the additive (e.g., carbon black) is decomposed and sublimed to decolorize the component.

### IV. Product Applications

The polymer composition of the present invention may be employed in a wide variety of potential product application, but is particularly suitable for use in electronic components, such as an electronic module. Such modules generally contain a housing that receives one or more electronic components (e.g., printed circuit board, antenna elements, radio frequency sensing elements, sensors, light sensing and/or transmitting elements (e.g., fibers optics), cameras, global positioning devices, etc.). The housing may, for instance, include a base that contains a sidewall extending therefrom. A cover may also be supported on the sidewall of the base to define an interior within which the electronic component(s) are received and protected from the exterior environment. Regardless of the particular configuration of the module, the composite may be used to form all or a portion of the housing and/or cover. In one embodiment, for instance, the composite may be used to form the base and sidewall of the housing. The cover may be formed from the polymer composition of the present invention or from a different material. Notably, one benefit of the present invention is that conventional heat sinks can be eliminated from the module design, thereby reducing the weight and overall cost of the module. Nevertheless, in certain other embodiments, such heat sinks may be employed. For example, the cover may contain an additional metal component (e.g., aluminum plate) in some cases.

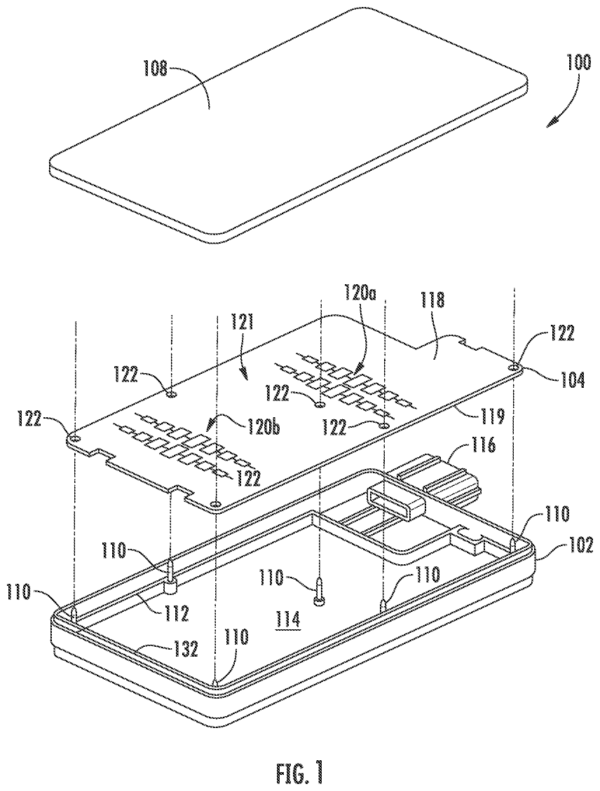

Referring to FIG. 1, for instance, one particular embodiment of an electronic module 100 is shown that may incorporate the composite of the present invention. The electronic module 100 includes a housing 102 that contains sidewalls 132 extending from a base 114. If desired, the housing 102 may also contain a shroud 116 that can accommodate an electrical connector (not shown). Regardless, a printed circuit board (“PCB”) is received within the interior of the module 100 and attached to housing 102. More particularly, the circuit board 104 contains holes 122 that are aligned with and receive posts 110 located on the housing 102. The circuit board 104 has a first surface 118 on which electrical circuitry 121 is provided to enable radio frequency operation of the module 100. For example, the RF circuitry 121 can include one or more antenna elements 120a and 120b. The circuit board 104 also has a second surface 119 that opposes the first surface 118 and may optionally contain other electrical components, such as components that enable the digital electronic operation of the module 100 (e.g., digital signal processors, semiconductor memories, input/output interface devices, etc.). Alternatively, such components may be provided on an additional printed circuit board. A cover 108 may also be employed that is disposed over the circuit board 104 and attached to the housing 102 (e.g., sidewall) through known techniques, such as by welding, adhesives, etc., to seal the electrical components within the interior. As indicated above, the polymer composition of the present invention may be used to form all or a portion of the cover 108 and/or the housing 102. As noted above, because it possesses a high degree of thermal conductivity, conventional heat sinks may be eliminated.

The electronic module may be used in a wide variety of applications. For example, the electronic module may be employed in an automotive vehicle (e.g., electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc.). When used in automotive applications, for instance, the electronic module may be used to sense the positioning of the vehicle relative to one or more three-dimensional objects. In this regard, the module may contain radio frequency sensing components, light detection or optical components, cameras, antenna elements, etc., as well as combinations thereof. For example, the module may be a radio detection and ranging (“radar”) module, light detection and ranging (“lidar”) module, camera module, global positioning module, etc., or it may be an integrated module that combines two or more of these components. Such modules may thus employ a housing that receives one or more types of electronic components (e.g., printed circuit board, antenna elements, radio frequency sensing devices, sensors, light sensing and/or transmitting elements (e.g., fibers optics), cameras, global positioning devices, etc.). In one embodiment, for example, a lidar module may be formed that contains a fiber optic assembly for receiving and transmitting light pulses that is received within the interior of a housing/cover assembly in a manner similar to the embodiments discussed above. Similarly, a radar module typically contains one or more printed circuit boards having electrical components dedicated to handling radio frequency (RF) radar signals, digital signal processing tasks, etc.

The electronic module may also be employed in a 5G system. For example, the electronic module may be an antenna module, such as macrocells (base stations), small cells, microcells or repeaters (femtocells), etc. As used herein, “5G” generally refers to high speed data communication over radio frequency signals. 5G networks and systems are capable of communicating data at much faster rates than previous generations of data communication standards (e.g., “4G, “LTE”). Various standards and specifications have been released quantifying the requirements of 5G communications. As one example, the International Telecommunications Union (ITU) released the International Mobile Telecommunications-2020 (“IMT-2020”) standard in 2015. The IMT-2020 standard specifies various data transmission criteria (e.g., downlink and uplink data rate, latency, etc.) for 5G. The IMT-2020 Standard defines uplink and downlink peak data rates as the minimum data rates for uploading and downloading data that a 5G system must support. The IMT-2020 standard sets the downlink peak data rate requirement as 20 Gbit/s and the uplink peak data rate as 10 Gbit/s. As another example, 3^{rd} Generation Partnership Project (3GPP) recently released new standards for 5G, referred to as “5G NR.” 3GPP published “Release 15” in 2018 defining “Phase 1” for standardization of 5G NR. 3GPP defines 5G frequency bands generally as “Frequency Range 1” (FR1) including sub-6 GHz frequencies and “Frequency Range 2” (FR2) as frequency bands ranging from 20-60 GHz. However, as used herein “5G frequencies” can refer to systems utilizing frequencies greater than 60 GHz, for example ranging up to 80 GHz, up to 150 GHz, and up to 300 GHz. As used herein, “5G frequencies” can refer to frequencies that are about 1.8 GHz or more, in some embodiments about 2.0 GHz or more, in some embodiments about 3.0 GHz or higher, in some embodiments from about 3 GHz to about 300 GHz, or higher, in some embodiments from about 4 GHz to about 80 GHz, in some embodiments from about 5 GHz to about 80 GHz, in some embodiments from about 20 GHz to about 80 GHz, and in some embodiments from about 28 GHz to about 60 GHz.

5G antenna systems generally employ high frequency antennas and antenna arrays for use in a 5G component, such as macrocells (base stations), small cells, microcells or repeaters (femtocell), etc., and/or other suitable components of 5G systems. The antenna elements/arrays and systems can satisfy or qualify as “5G” under standards released by 3GPP, such as Release 15 (2018), and/or the IMT-2020 Standard. To achieve such high speed data communication at high frequencies, antenna elements and arrays generally employ small feature sizes/spacing (e.g., fine pitch technology) that can improve antenna performance. For example, the feature size (spacing between antenna elements, width of antenna elements) etc. is generally dependent on the wavelength (“λ”) of the desired transmission and/or reception radio frequency propagating through the substrate on which the antenna element is formed (e.g., nλ/4 where n is an integer). Further, beamforming and/or beam steering can be employed to facilitate receiving and transmitting across multiple frequency ranges or channels (e.g., multiple-in-multiple-out (MIMO), massive MIMO). The high frequency 5G antenna elements can have a variety of configurations. For example, the 5G antenna elements can be or include co-planar waveguide elements, patch arrays (e.g., mesh-grid patch arrays), other suitable 5G antenna configurations. The antenna elements can be configured to provide MIMO, massive MIMO functionality, beam steering, etc. As used herein “massive” MIMO functionality generally refers to providing a large number transmission and receiving channels with an antenna array, for example 8 transmission (Tx) and 8 receive (Rx) channels (abbreviated as 8×8). Massive MIMO functionality may be provided with 8×8, 12×12, 16×16, 32×32, 64×64, or greater.

The antenna elements may be fabricated using a variety of manufacturing techniques. As one example, the antenna elements and/or associated elements (e.g., ground elements, feed lines, etc.) can employ fine pitch technology. Fine pitch technology generally refers to small or fine spacing between their components or leads. For example, feature dimensions and/or spacing between antenna elements (or between an antenna element and a ground plane) can be about 1,500 micrometers or less, in some embodiments 1,250 micrometers or less, in some embodiments 750 micrometers or less (e.g., center-to-center spacing of 1.5 mm or less), 650 micrometers or less, in some embodiments 550 micrometers or less, in some embodiments 450 micrometers or less, in some embodiments 350 micrometers or less, in some embodiments 250 micrometers or less, in some embodiments 150 micrometers or less, in some embodiments 100 micrometers or less, and in some embodiments 50 micrometers or less. However, it should be understood that feature sizes and/or spacings that are smaller and/or larger may also be employed. As a result of such small feature dimensions, antenna configurations and/or arrays can be achieved with a large number of antenna elements in a small footprint. For example, an antenna array can have an average antenna element concentration of greater than 1,000 antenna elements per square centimeter, in some embodiments greater than 2,000 antenna elements per square centimeter, in some embodiments greater than 3,000 antenna elements per square centimeter, in some embodiments greater than 4,000 antenna elements per square centimeter, in some embodiments greater than 6,000 antenna elements per square centimeter, and in some embodiments greater than about 8,000 antenna elements per square centimeter. Such compact arrangement of antenna elements can provide a greater number of channels for MIMO functionality per unit area of the antenna area. For example, the number of channels can correspond with (e.g., be equal to or proportional with) the number of antenna elements.

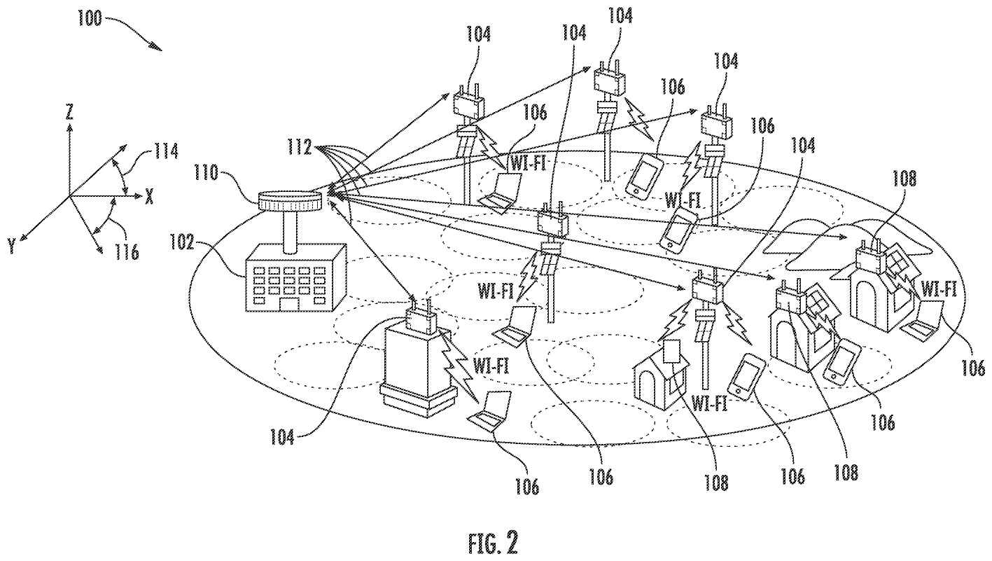

Referring to FIG. 2, for example, a 5G antenna system 100 can include a base station 102, one or more relay stations 104, one or more user computing devices 106, one or more Wi-Fi repeaters 108 (e.g., “femtocells”), and/or other suitable antenna components for the 5G antenna system 100. The relay stations 104 can be configured to facilitate communication with the base station 102 by the user computing devices 106 and/or other relay stations 104 by relaying or “repeating” signals between the base station 102 and the user computing devices 106 and/or relay stations 104. The base station 102 can include a MIMO antenna array 110 configured to receive and/or transmit radio frequency signals 112 with the relay station(s) 104, Wi-Fi repeaters 108, and/or directly with the user computing device(s) 106. The user computing device 306 is not necessarily limited by the present invention and include devices such as 5G smartphones. The MIMO antenna array 110 can employ beam steering to focus or direct radio frequency signals 112 with respect to the relay stations 104. For example, the MIMO antenna array 110 can be configured to adjust an elevation angle 114 with respect to an X-Y plane and/or a heading angle 116 defined in the Z-Y plane and with respect to the Z direction. Similarly, one or more of the relay stations 104, user computing devices 106, Wi-Fi repeaters 108 can employ beam steering to improve reception and/or transmission ability with respect to MIMO antenna array 110 by directionally tuning sensitivity and/or power transmission of the device 104, 106, 108 with respect to the MIMO antenna array 110 of the base station 102 (e.g., by adjusting one or both of a relative elevation angle and/or relative azimuth angle of the respective devices).

### Test Methods

Thermal Conductivity: As is known in the art, the thermal diffusivity of a sample in various directions (in-plane, cross-plane, through-plane) may be initially determined based on the laser flash method in accordance with ASTM E1461-13(2022). The thermal conductivity (in-plane, cross-plane, and through-plane) may then be calculated according to the following formula: Thermal Conductivity (W/m*K)=Cp*ρ*α, where Cp is the specific heat capacity (J/kgK) of the sample, ρ is the intrinsic density (kg/m³) of the sample as determined in accordance with ISO 11831-1:2019 (Method A), and α is the measured thermal diffusivity (m²/s).

Tensile Modulus, Tensile Stress at Break, and Tensile strain at Break: Tensile properties may be tested according to ISO 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min for tensile strength and tensile strain at break, and 1 mm/min for tensile modulus. For testing, the sample is initially molded using a feed throat temperature of 40-50° C., temperature at heating zone 1 of 250-260° C., temperature at heating zone 2 of 250-260° C., temperature at heating zone 3 of 250-260° C., temperature at heating zone 4 of 250-260° C., nozzle temperature of 250-260° C., molding temperature (stationary) of 80° C., and molding temperature (moveable) of 80° C.

Flexural Modulus and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C. For “notched” impact strength, this test may be run using a Type A notch (0.25 mm base radius) and Type 1 specimen size (length of 80 mm, width of 10 mm, and thickness of 4 mm).

Hydrolytic Resistance: Hydrolytic resistance may measured using a “Hydrolysis Test”, which may be conducted at 121° C. by placing a test plaque in a pressure cooker for a specific length of time, such as 96 hours or 168 hours. The pressure cooker uses moist heat in the form of saturated steam under pressure. The operating range of the pressure cooker is 15 to 21 psi (using the Geared Steam Gauge). The exposure period begins when the pressure steam gauge needle registers within the above operation range (15 to 21 psi). During the test, the temperature can vary from 121° C. to 127° C. After the determined amount of time, the mechanical properties of the test plaque may be measured and compared with initial properties.

Electromagnetic Interference (“EMP”) Shielding: EMI shielding effectiveness may be determined in accordance with ASTM D4935-18 at frequency ranges ranging from 1.5 GHz to 10 GHz (e.g., 5 GHz). The thickness of the parts tested may vary, such as 1 millimeter, 1.6 millimeters, or 3 millimeters. The test may be performed using an EM-2108 standard test fixture, which is an enlarged section of coaxial transmission line and available from various manufacturers, such as Electro-Metrics. The measured data relates to the shielding effectiveness due to a plane wave (far field EM wave) from which near field values for magnetic and electric fields may be inferred.

Comparative Tracking Index (“CTI”): The comparative tracking index (CTI) may be determined in accordance with International Standard IEC 60112-2020 to provide a quantitative indication of the ability of a composition to perform as an electrical insulating material under wet and/or contaminated conditions. For testing, a sample is initially molded using a feed throat temperature of 40-50° C., temperature at heating zone 1 of 260-270° C., temperature at heating zone 2 of 260-270° C., temperature at heating zone 3 of 270-280° C., temperature at heating zone 4 of 270-280° C., nozzle temperature of 270-280° C., molding temperature (stationary) of 120° C., and molding temperature (moveable) of 120° C. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm. The two sets are conditioned before and after aging. For unaged testing, each thickness is tested after conditioning for 48 hours at 23° C. and 50% relative humidity. For aged testing, five (5) samples of each thickness are tested after conditioning for 7 days at 70° C.

| Vertical | |
|---|---|
| Ratings | Requirements |
| V-0 | Specimens must not burn with flaming combustion for more than |
| | 10 seconds after either test flame application. |
| | Total flaming combustion time must not exceed 50 seconds for |
| | each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 30 seconds after removal of the test flame. |
| V-1 | Specimens must not burn with flaming combustion for more than |
| | 30 seconds after either test flame application. |
| | Total flaming combustion time must not exceed 250 seconds for |
| | each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 60 seconds after removal of the test flame. |
| V-2 | Specimens must not burn with flaming combustion for more than |
| | 30 seconds after either test flame application. |
| | Total flaming combustion time must not exceed 250 seconds for |
| | each set of 5 specimens. |
| | Specimens must not burn with flaming or glowing combustion |
| | up to the specimen holding clamp. |
| | Specimens can drip flaming particles that ignite the cotton. |
| | No specimen can have glowing combustion remain for longer |
| | than 60 seconds after removal of the test flame. |

### Comparative Example 1

A commercially available resin sample is formed from the components listed in the tables below. PBT 1 is polyethylene terephthalate (Celanex® JXK 1040) having a melt flow rate of 110 g/10 min at 250° C. and load of 2.16 kg and PBT 2 is polybutylene terephthalate (Celanex® JKX 1035) having a melt flow rate of 10 g/10 min at 250° C. and load of 2.16 kg.

Comp. Ex. 1

| | Wt. % | Parts |
|---|---|---|
| PBT 1 | 49 | 100 |
| PBT 2 | 21 | |
| Glass Fibers | 30 | 43 |

The samples noted above is tested for mechanical properties and thermal conductivity as described herein. The results are set forth below.

| | | | | Charpy Impact | | TC | TC, | TC, | |
|---|---|---|---|---|---|---|---|---|---|
| | Tensile | Tensile | Tensile | Strength | MVR | In- | Cross | Through | |
| | Modulus | Strength | Elong. | (Un-Notched) | (cm³/10 | Plane | Plane | Plane | CTI |
| | (MPa) | (MPa) | (%) | (kJ/m²) | min) | (W/mK) | (W/mK) | (W/mK) | (V) |
| Comp | 9,426 | 134.8 | 2.8 | 46.1 | 15.7 | 0.5 | 0.4 | 0.2 | 350 |
| Ex. 1 | | | | | | | | | |

### Examples 1-3

Three (3) resin samples are formed from the components listed in the tables below. Talc 1 is talc particles (HTP4 from Fabi) having a median diameter of 7.5 μm, specific surface area (B.E.T.) of 3.5 m²/g, and moisture content of 0.2% at 105° C.

| | Ex. 1 | | Ex. 2 | | Ex. 3 | |
|---|---|---|---|---|---|---|
| | Wt. % | Parts | Wt. % | Parts | Wt. % | Parts |
| PBT 1 | 28 | 100 | 28 | 100 | 28 | 100 |
| PBT 2 | 12 | | 12 | | 12 | |
| Talc 1 | 60 | 150 | 45 | 112 | 30 | 75 |
| Glass Fibers | — | — | 15 | 38 | 30 | 75 |

The samples noted above are also tested for mechanical properties and thermal conductivity as described herein. The results are set forth below.

| | | | | Charpy Impact | | TC | TC, | TC, | |
|---|---|---|---|---|---|---|---|---|---|
| | Tensile | Tensile | Tensile | Strength | MVR | In- | Cross | Through | |
| | Modulus | Strength | Elong. | (Un-Notched) | (cm³/10 | Plane | Plane | Plane | CTI |
| | (MPa) | (MPa) | (%) | (kJ/m²) | min) | (W/mK) | (W/mK) | (W/mK) | (V) |
| Ex. 1 | 11,500 | 53.3 | 0.8 | 8.7 | 2.6 | 4.3 | 3.7 | 0.8 | 550 |
| Ex. 2 | 13,557 | 68.7 | 0.8 | 15.6 | 3.1 | 3.1 | 2.6 | 0.9 | 500 |
| Ex. 3 | 14,992 | 87.3 | 1.0 | 19.9 | 2.4 | 1.9 | 1.5 | 0.9 | 425 |

### Examples 4-7

Four (4) resin samples are formed from the components listed in the tables below. Impact Modifier 1 is a copolymer of 84 wt. % ethylene and 16 wt. % ethyl acrylate that has a melt index of 1 g/10 min at 190° C. and 2.16 kg (Elvaloy® 2116 AC). Impact Modifier 2 is a copolymer of 8 wt. % glycidyl methacrylate, 24 wt. % methyl acrylate, 68 wt. % ethylene that has a melt index of 6 g/10 min at 190° 0 and 2.16 kg (Lotader® AX8900). Impact Modifier 3 is a copolymer of 8 wt. % glycidyl methacrylate and 92 wt. % ethylene that has a melt index of 5 g/10 min at 190° C. and 2.16 kg (Lotader® AX8840).

| | Ex. 4 | | Ex. 5 | | Ex. 6 | | Ex. 7 | |
|---|---|---|---|---|---|---|---|---|
| | Wt. % | Parts | Wt. % | Parts | Wt. % | Parts | Wt. % | Parts |
| PBT 1 | 24.1 | 100 | 21.6 | 100 | 21.6 | 100 | 21.6 | 100 |
| PBT 2 | 24.1 | | 21.6 | | 21.6 | | 21.6 | |
| Talc 1 | 35 | 73 | 35 | 81 | 35 | 81 | 35 | 81 |
| Impact Modifier 1 | — | — | 5 | 12 | — | — | — | — |
| Impact Modifier 2 | — | — | — | — | 5 | 12 | — | — |
| Impact Modifier 3 | — | — | — | — | — | — | 5 | 12 |
| Glass Fibers | 15 | 31 | 15 | 35 | 15 | 35 | 15 | 35 |
| Antioxidants | 0.3 | 0.6 | 0.3 | 0.7 | 0.3 | 0.7 | 0.3 | 0.7 |
| Black Masterbatch | 1.5 | 3.1 | 1.5 | 3.5 | 1.5 | 3.5 | 1.5 | 3.5 |

The samples noted above are also tested for mechanical properties and thermal conductivity as described herein. The results are set forth below.

| | | | | Charpy Impact | | TC | TC, | TC, |
|---|---|---|---|---|---|---|---|---|
| | Tensile | Tensile | Tensile | Strength | MVR | In- | Cross | Through |
| | Modulus | Strength | Elong. | (Un-Notched) | (cm³/10 | Plane | Plane | Plane |
| | (MPa) | (MPa) | (%) | (kJ/m²) | min) | (W/mK) | (W/mK) | (W/mK) |
| Ex. 4 | 11,723 | 82.9 | 1.4 | 24.3 | 5.1 | 1.7 | 1.6 | 0.7 |
| Ex. 5 | 10,433 | 72.4 | 1.3 | 24.4 | 3.5 | 1.7 | 1.5 | 0.7 |
| Ex. 6 | 9,008 | 72.7 | 2.1 | 28.6 | — | 1.6 | 1.5 | 0.7 |
| Ex. 7 | 9,437 | 75.4 | 2.0 | 27.6 | — | 1.8 | 1.6 | 0.7 |

### Examples 8-11

Four (4) resin samples are formed from the components listed in the tables below.

| | Ex. 8 | | Ex. 9 | | Ex. 10 | | Ex. 11 | |
|---|---|---|---|---|---|---|---|---|
| | Wt. % | Parts | Wt. % | Parts | Wt. % | Parts | Wt. % | Parts |
| PBT 1 | 31.5 | 100 | 31.5 | 100 | 31.5 | 100 | 31.5 | 100 |
| PBT 2 | 13.5 | | 13.5 | | 13.5 | | 13.5 | |
| Talc 1 | 40 | 89 | 30 | 67 | 30 | 67 | 30 | 67 |
| Boron Nitride | — | — | 10 | 12 | — | — | — | — |
| Zinc Oxide | — | — | — | — | 10 | 12 | — | — |
| (Azo 66P RF199) | | | | | | | | |
| Zinc Oxide | — | — | — | — | — | — | 10 | 12 |
| (Pana-Tetra WZ-0531) | | | | | | | | |
| Glass Fibers | 15 | 33 | 15 | 33 | 15 | 33 | 15 | 33 |

The samples noted above are also tested for mechanical properties and thermal conductivity as described herein. The results are set forth below.

| | | | | Charpy Impact | | TC | TC, | TC, |
|---|---|---|---|---|---|---|---|---|
| | Tensile | Tensile | Tensile | Strength | MVR | In- | Cross | Through |
| | Modulus | Strength | Elong. | (Un-Notched) | (cm³/10 | Plane | Plane | Plane |
| | (MPa) | (MPa) | (%) | (kJ/m²) | min) | (W/mK) | (W/mK) | (W/mK) |
| Ex. 8 | 12,651 | 80.8 | 1.2 | 20.8 | 5.2 | 2.2 | 1.8 | 0.7 |
| Ex. 9 | 13,825 | 78.5 | 1.0 | 18.7 | 2.7 | 3.3 | 2.9 | 0.9 |
| Ex. 10 | 11,387 | 52.0 | 0.6 | 8.9 | 23.7 | 1.8 | 1.6 | 0.8 |
| Ex. 11 | 12,329 | 80.9 | 1.1 | 23.0 | 5.3 | 1.9 | 1.7 | 0.8 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polymer composition comprising a polymer matrix that includes an aromatic polyester and an inorganic filler dispersed within the polymer matrix that includes inorganic particles and optionally inorganic fibers, wherein the inorganic filler is present in an amount of from about 60 parts to about 200 parts by weight per 100 parts by weight of the polymer matrix and the inorganic particles are present in an amount of from about 40 to about 200 parts by weight per 100 parts by weight of the polymer matrix, wherein the polymer composition exhibits an in-plane thermal conductivity of about 1.5 W/m-K or more as determined in accordance with ASTM E1461-13(2022) and a melt flow rate of from about 0.1 to about 50 g/10 min as determined in accordance with ISO 1133:2022 at a temperature of about 250° C. and load of 2.16 kg.

2. The polymer composition of claim 1, wherein the polymer composition exhibits a cross-plane thermal conductivity of about 1 W/m-K or more as determined in accordance with ASTM E 1461-13(2022).

3. The polymer composition of claim 1, wherein the polymer matrix constitutes from about 30 wt. % to about 70 wt. % of the polymer composition.

4. The polymer composition of claim 1, wherein the aromatic polyester is poly(ethylene terephthalate), poly(1,4-butylene terephthalate), poly(1,3-propylene terephthalate), poly(1,4-butylene 2,6-naphthalate), poly(ethylene 2,6-naphthalate), poly(1,4-cyclohexylene dimethylene terephthalate), or a combination thereof.

5. The polymer composition of claim 1, wherein the composition includes glass fibers.

6. The polymer composition of claim 5, wherein the glass fibers are coated with a sizing composition.

7. The polymer composition of claim 6, wherein the coated glass fibers have a moisture content of about 0.5 wt. % or less.

8. The polymer composition of claim 1, wherein the inorganic particles constitute from about 20 wt. % to about 70 wt. % of the polymer composition.

9. The polymer composition of claim 1, wherein the inorganic particles include metal silicate particles.

10. The polymer composition of claim 9, wherein the metal silicate particles include talc.

11. The polymer composition of claim 1, wherein the inorganic particles include metal hydroxide particles.

12. The polymer composition of claim 1, wherein the inorganic particles include metal oxide particles.

13. The polymer composition of claim 1, wherein the inorganic particles have a median diameter of from about 1 to about 25 micrometers.

14. The polymer composition of claim 1, wherein the inorganic particles have a specific surface area of from about 1 to about 100 m²/g as determined in accordance with DIN 66131:1993, and/or moisture content of about 5% or less as determined in accordance with ISO 787-2:1981 at a temperature of 105° C.

15. The polymer composition of claim 1, further comprising an impact modifier.

16. The polymer composition of claim 1, wherein the polymer composition is free of fillers having an intrinsic thermal conductivity of 100 W/m-K or more.

17. An electronic module comprising a housing that receives at least one electronic component, wherein the housing contains the polymer composition of claim 1.

18. The electronic module of claim 17, wherein the module is a radar module or a lidar module.

19. The electronic module of claim 17, wherein the electronic component includes a camera.

20. An electric vehicle comprising a powertrain that includes at least one electric propulsion source and a transmission that is connected to the propulsion source via at least one power electronics module, wherein the electric vehicle comprises the electronic module of claim 18.
